(19) United States
(12) Patent Application Publication
(10) Pub. No.: US 2012/0061608 A1
(43) Pub. Date: Mar. 15, 2012

(54) FUNCTIONAL PARTICLE WITH ROUGH-SURFACED POLYMER COATING

(75) Inventors: Masakazu MITSUNAGA, Osaka (JP); Naoki USUKI, Osaka (JP); Kenji KOHNO, Osaka (JP); Hisao KANZAKI, Osaka (JP)

(73) Assignee: HITACHI MAXELL, LTD., Osaka (JP)

(21) Appl. No.: 13/228,286

(22) Filed: Sep. 8, 2011

(30) Foreign Application Priority Data
Sep. 10, 2010 (JP) 2010-202710
Jan. 31, 2011 (JP) 2011-018409

(51) Int. Cl. H01F 1/03; H01F 41/02

(52) U.S. Cl. 252/62.54; 427/127

(57) ABSTRACT

There is provided a magnetic particle to which a large amount of target substance can bind upon separation, analysis and the like of the target substance, the particle exhibiting a higher rate of the magnetic separation. The magnetic particle to which a target substance can bind, comprising a core particle having magnetism and a polymer coat layer comprising a polymer shell portion in which a rough coating of polymer is provided on a surface of the core particle. This magnetic particle has a roughness due to a surface roughness of the polymer shell portion wherein a specific surface area (m²/g) of the magnetic particle is 1.5 to 500 times a specific surface area (m²/g) of the core particle when the core particle is regarded as a smooth perfect sphere.

### TECHNICAL FIELD

The present invention relates to a functional particle suited for a separation, immobilization, analysis, extraction, purification, reaction or the like of a target substance. In particular, the present invention relates to a rough-polymer coated functional particle having magnetism.

### BACKGROUND OF THE INVENTION

Composite particles capable of specifically binding to or reacting with particular kinds of target substances have conventionally been well known as functional materials for use in biochemical applications. Examples of such applications using the particles include a quantitative determination, a separation, a purification and an analysis of the target substances (e.g. cells, proteins, nucleic acids and chemical substances). See Patent Documents 1 and 2 described below. The above composite particles are magnetized particles which can be for example produced by incorporating a magnetic material into nonmagnetic beads. When the composite particles are used for the purpose of separating the target substances from a sample, the composite particles are added to the sample containing the target substances in order to allow the target substances to bind to the surfaces of composite particles. Subsequently, a magnetic field is applied in order to allow the composite particles to move to assemble and aggregate in the sample. By collecting and recovering the assembled and aggregated composite particles, the target substance together with the composite particles can be separated. This method makes use of the magnetic field or magnetism (the method using the magnetic field or magnetism hereinafter can be also referred to as “magnetic separation method” or simply referred to as “magnetic separation”). Therefore, this method has such a feature that it can be carried out even if the amount of the sample is smaller than the amount required for use in a centrifugal separation method, a column separation method, an electrophoresis method or the like, and also it can be carried out in a short time without causing a denaturation of the target substances.

As for the particles which are especially intended for the analysis of the target substances, there are polymer particles used in a latex agglutination immunology turbidimetric method.

Such particles (see Patent Document 1) for use in the biochemical applications generally have particle diameter in the range of nanometers to micrometers, and have such a particle structure that superparamagnetic sub-particles with their diameter being several nanometers to several tens of nanometers have precipitated in the porous polymer particulate material. They have large specific surface areas attributed to the porous polymer material so that they are capable of binding to a large amount of the target substances. However, they do not have large portion of magnetic material in their polymer material, which will cause a slowed velocity of the particles in the magnetic separation method.

### RELATED ART DOCUMENTS

### Patent Documents

[Patent Document 1] Japanese Patent Kohyo Publication No. S59-500691
[Patent Document 2] Japanese Patent Kohyo Publication No. H04-501956

### SUMMARY OF THE INVENTION

### Problems to be Solved by the Invention

Under the above circumstances, the present invention has been created. That is, an object of the present invention is to provide a particle to which a large amount of target substance can bind upon separation, analysis or the like of the target substance, exhibiting a higher rate of the magnetic separation. Another object of the present invention is to provide a particle which particularly exhibits not only an excellent dispersibility, but also a higher rate of the magnetic separation in spite of its small particle diameter of submicron. Still another object of the present invention is to provide particles which exhibit a more uniform distribution of particle diameters within a water-based medium wherein the particles can respectively have more uniform reactivities with respect to the target substances.

### Means for Solving the Problem

In order to achieve the above objects, the present invention provides a magnetic particle to which a target substance can bind, comprising:

a core particle having magnetism;

a polymer coat layer comprising a polymer shell portion (i.e., rough-polymer coating portion) in which a rough coating of polymer is provided on a surface of the core particle;

wherein the magnetic particle has a roughness due to a surface roughness of the polymer shell portion;

a specific surface area (m²/g) of the magnetic particle is 1.5 to 500 times a specific surface area (m²/g) of the core particle when the core particle is regarded as a smooth perfect sphere; and

a substance or functional group capable of binding to the target substance is immobilized on the core particle and/or the polymer coat layer.

The particle of the present invention is characterized in that it is a magnetic particle roughened by the polymer. In particular, the magnetic particle of the present invention has a hubbly core-shell structure wherein the core is composed of the particle having magnetism, and a rough coating of polymer is provided on the surface of the core.

In preferred aspect, the polymer shell portion is provided on the surface of the core particle due to a chemical bond between the polymer shell portion and the core particle. This means that a continuous coating of the polymer shell portion is provided on at least part of the surface of the core particle. In other words, the polymer shell portion is provided in its continuous form on the whole surface or a part of surface of the core particle. The term “continuous” as used herein means an embodiment wherein the body of the polymer shell portion, which is provided on the whole surface or a part of surface of the core particle, does not have a partially-separated form. As such, the term “continuous” substantially means an embodiment wherein the polymer shell portion has a form such that it has no void portion in the body thereof (particularly it has no “void portion enabling an exposure of the surface of the core particle” in the body thereof).

In another preferred aspect of the present invention, the polymer shell portion entirely surrounds the core particle so that it prevents an exposure of the surface of the core particle. Namely, the hubbly polymer shell portion entirely surrounds the core particle such that the polymer shell portion has a thickness capable of preventing the exposure of the surface of the core particle.

As used herein, the term “rough”/“roughness”/“roughening”/“roughened” substantially means an embodiment wherein a coating polymer, which is provided on a surface of a core particle, itself has a surface roughness, and thus a surface area of the magnetic particle is entirely increased by such surface roughness of the core particle. Therefore, the phrase “rough coating” substantially means an embodiment wherein a coating of polymer is provided so that a particle of interest has increased surface area due to the surface roughness of the polymer coating.

Due to the roughness attributed to the surface roughness which the coating polymer has, the magnetic particle of the present invention has a specific surface area (m²/g) which is 1.5 to 500 times a specific surface area (m²/g) of the core particle when the core particle is regarded as a smooth perfect sphere. As used herein, the term “smooth perfect sphere” substantially means a sphere whose shape is a true sphere in terms of geometry. The term “true sphere” means a sphere wherein all the diameters passing through the center of the sphere have substantially the same length. Accordingly, the phrase “a specific surface area (m²/g) of the magnetic particle is 1.5 to 500 times a specific surface area (m²/g) of the core particle when the core particle is regarded as a smooth perfect sphere” substantially means that a value of the specific surface area (m²/g) of the magnetic particle according to the present invention is 1.5 to 500 times larger than that of the specific surface area (m²/g) of a true spherical particle having the same particle diameter and the same density as those of the core particle. For example, “a specific surface area (m²/g) of the core particle when the core particle is regarded as a smooth perfect sphere” may be calculated from a diameter of a true circle having the same area as a core particle area that is obtained from the number of the pixels in a core particle image of an electron micrograph or an optical micrograph. In this regard, the value of the specific surface area is usually obtained as a mean value of those of a plurality of particles. Thus, the particle diameter for the calculation of the specific surface area can be used as an average particle diameter obtained by measuring each particle diameter of for example 300 particles based on the image and then calculating the number average thereof. For the measurement of the (average) particle diameter from the image, an image processing software (e.g. “Image-Pro Plus” manufactured by Media Cybernetics, Inc.) can be utilized. Summarizing the above matters, the phrase “specific surface area (m²/g) of the core particle when the core particle is regarded as a smooth perfect sphere” substantially means a specific surface area of the true spherical particle which has a diameter D corresponding to an average diameter L of the true circles having the same areas as the areas of the images on the core particles wherein the density of the true spherical particle is the same as the density of the core particle.

The magnetic particle of the present invention has “substance or functional group capable of binding to a target substance” immobilized on the surface thereof. In other words, “substance or functional group to which a target substance can bind” is immobilized on the polymer coat layer and/or the core particle. Therefore, when the magnetic particle of the present invention and the target substance coexist with each other, the target substance can bind to the particle. Therefore, the particle of the present invention can be used for not only various applications such as separation, purification and extraction of the target substances, but also applications of tailor-made medical technologies. As used in this description and claims, the term “target substance” substantially means an object substance in various applications such as separation, extraction, quantitative determination, purification and analysis. “Target substance” may be any suitable substance as long as it can bind to the particle directly or indirectly. Examples of the target substance include nucleic acids, proteins (e.g. avidin, biotinylated HRP and the like), sugars, lipids, peptides, cells, eumycetes (fungus), bacteria, yeasts, viruses, glycolipids, glycoproteins, complexes, inorganic substances, vectors, low molecular compounds, high molecular compounds, antibodies and antigens. Considering that the particle of the present invention can be used for separation, purification, extraction and analysis of various target substances, the particle can have various functions. It should be therefore noted that the particle of the present invention can be called “functional particle”.

In preferred aspect, the polymer shell portion comprises an aromatic vinyl backbone. It is particularly preferred that the aromatic vinyl backbone is a divinylbenzene backbone and/or a divinylbenzene derivative backbone. In further preferred aspect, the polymer shell portion comprises, in the molecule thereof, at least one kind of backbone and functional group selected from the group consisting of a divinylbenzene backbone, backbones of divinylbenzene derivatives, a carboxyl group, a polyethylene glycol group, styrene, backbones of styrene derivatives, a sulfonic acid group, a sulfuric acid ester group, phosphoric acid ester group of choline and an amino group.

In preferred aspect, a particle diameter of the core particle is in the range of 5 nm to 3 μm. This means that a magnetic portion serving as a core of the magnetic particle has a diameter of 5 nm to 3 μm.

In another preferred aspect, the polymer coat layer further comprises a hydrophilic polymer coat portion (i.e., hydrophilic polymer portion) in addition to the polymer shell portion. In this case, the hydrophilic polymer coat portion (hydrophilic polymer portion) may be located outside of the polymer shell portion in the polymer coat layer.

In still another preferred aspect, the core particle has a spherical shape. Especially, the core particle has such a spherical shape that a ratio of the largest radius to the smallest radius regarding the core particle is in the range of 1.0 to 1.3. In a case where the magnetic particle comprises the spherical core particle, Coefficient of Variation (CV value) which represents a distribution of particle diameters of the core particles is not more than 18%. The term “CV value” as used herein means Coefficient of Variation. More specifically, term “CV value” is a coefficient calculated by statistically processing the whole data of the measurement result of the particle diameters (especially the measurement result for diameters of core particles), and thus is expressed by the following Formula 1:

$$\begin{matrix}\begin{matrix}CV value ( \% ) = \frac{ \begin{matrix}Standard Deviation of \\ Particle Diameter Distribution\end{matrix}}{Average Particle Diameter} \times 100 \\ = \frac{S}{\overline{r}} \times 100\end{matrix} & ( Formula 1 ) \\ ( \begin{matrix}S \text{:} \begin{matrix}Standard Deviation of \\ Particle Diameter Distribution\end{matrix} = \sqrt{\frac{1}{N} {\sum }_{k = 1}^{N} {( {r}_{k} - \overline{r} )}^{2}} \\ \overline{r} \text{:} Average Particle Diameter = \frac{1}{N} {\sum }_{k = 1}^{N} {r}_{k} \\ {r}_{k} \text{:} Respective Diameters of Particles \\ N \text{:} Number of Particeles\end{matrix} ) & \end{matrix}$$

It is preferred that a saturation magnetization of the magnetic particle according to the present invention is in the range of 2 A·m²/kg to 100 A·m²/kg. For example, the saturation magnetization of the magnetic particle is in the range of 20 A·m²/kg to 100 A·m²/kg. It is preferred that a coercive force of the magnetic particle according to the present invention is in the range of 0.3 kA/m to 15.93 kA/m (3.8 to 200 oersteds). For example, the coercive force of the magnetic particle may be in the range of 0.79 kA/m to 15.93 kA/m (10 to 200 oersteds). Especially in a case of the spherical core particle, the coercive force of the magnetic particle may be in the range of 0.3 kA/m to 6.5 kA/m (3.8 to 81.7 oersteds), or may be in the range of 0.399 kA/m to 6.38 kA/m (5 to 80 oersteds).

In the magnetic particle of the present invention, the substance capable of binding to the target substance may be at least one kind of a substance selected from the group consisting of biotin, avidin, streptavidin, neutravidin, protein A and protein G. Similarly, the functional group capable of binding to the target substance may be at least one kind of a functional group selected from the group consisting of carboxyl group, hydroxyl group, epoxy group, tosyl group, succinimide group, maleimide group, thiol group, thioether group, disulfide group, aldehyde group, azido group, hydrazide group, primary amino group, secondary amino group, tertiary amino group, imide ester group, carbodiimide group, isocyanate group, iodoacetyl group, halogen-substitution of carboxyl group and double bond.

The present invention also provides a method for producing the magnetic particle whose polymer coat layer comprises the polymer shell portion. Specifically, the production method of the present invention is a method for producing a magnetic particle to which a target substance can bind, comprising the step of mixing a precursor particle which corresponds to a core particle of the magnetic particle, a monomer and a solvent with each other, and thereby chemically bonding a polymer component derived from the monomer with the precursor particle. In the above step, a polymer shell portion of the magnetic particle, which is made of the chemically-bonded polymer component, is continuously formed on at least part of the surface of the core particle, and thereby roughening the magnetic particle by a surface roughness of the polymer shell portion.

As used herein, the phrase “chemically bonding (or chemically bonded)” means a so-called “chemical bond” in terms of a general technical meaning, and thus may be one as described in “Kagaku Daijiten 2” (Kyoritsu Shuppan Co., Ltd., Kagaku Daijiten Henshu Iinkai, page 299), for example. Especially as for the present invention, the meaning of “chemical bond” has a conflicting relationship with “physical adsorption” and “magnetic adsorption”.

In preferred aspect, an aromatic vinyl monomer is used as the monomer, and thereby forming the polymer shell portion comprising an aromatic vinyl backbone (e.g., divinylbenzene backbone and/or divinylbenzene derivative backbone) onto the surface of the core particle.

The present invention also provides a method for producing the magnetic particle whose polymer coat layer comprises the polymer shell portion and the hydrophilic polymer coat portion. Specifically, the production method of the present invention is a method for producing a magnetic particle to which a target substance can bind, comprising the steps of

(i) subjecting a precursor particle which corresponds to a core particle of the magnetic particle to a rough-polymer coating treatment, and thereby forming a polymer shell portion on a surface of the precursor particle (i.e., roughening the precursor particle by the polymer coating); and

(ii) subjecting the precursor particle from the rough-polymer coating treatment (i.e., the roughened precursor particle) to a hydrophilic-polymer coating treatment, and thereby forming a hydrophilic polymer coat portion on the precursor particle;

wherein the precursor particle is subjected to a physical dispersion treatment at a point in time between the rough-polymer coating treatment of the step (i) and the hydrophilic-polymer coating treatment of the step (ii).

As used in this description and claims, the term “physical dispersion treatment” means a treatment for applying an external force to the precursor particle. Particularly, it substantially means an operation of applying an external force to the precursor particles having a form of aggregation to reduce the aggregate state thereof. As used herein, the phrase “physical treatment” of “physical dispersion treatment” has a conflicting relationship with “chemical treatment” such as “rough-polymer coating treatment” and “hydrophilic-polymer coating treatment”.

In preferred aspect, a shear force is applied to the precursor particle in the physical dispersion treatment. In particular, an external force is applied to the aggregated precursor particles in a medium to exert the shear force on such precursor particles, and thereby the aggregate state of the precursor particles is reduced. For example, a passing of the precursor particles (especially, a precursor particles-containing liquid) through a slit under pressure is performed to reduce the aggregate state of the precursor particles.

The step (i) of the production method according to the present invention may be carried out according to the above-mentioned aspect. In other words, upon performing the rough-polymer coating treatment, the precursor particles, a monomer and a solvent are mixed with each other, and thereby a polymer component derived from the monomer is allowed to chemically bond with the precursor particles, in which case the polymer shell portion made of the chemically-bonded polymer component is continuously formed on at least part of the surface of each core particle, and thereby roughening each of the magnetic particles by a surface roughness of the polymer shell portion.

The production method of the present invention further comprises a treatment for immobilizing “substance or functional group capable of binding to the target substance” onto the particle. Namely, the production method of the present invention further comprises a treatment for immobilizing “substance or functional group capable of binding to the target substance” onto the polymer coat layer and/or the core particle.

Especially in a case where the magnetic particle is made up of the spherical core particle, such core particle may be prepared by a method comprising the following steps of:

(I) mixing an iron ion-containing solution and an alkaline solution with each other, and thereby precipitating an iron element-containing hydroxide in the resulting solution mixture, and

(II) subjecting the solution mixture to a heat treatment to form a particle having a magnetism from the hydroxide.

In a preferred aspect for the preparation of the core particle having magnetism, in the step (II), the hydroxide is subjected to a solvothermal reaction in the solution mixture which contains water and glycerin. In another preferred aspect, the mixture solution is irradiated with microwave in the heat treatment of the step (II). Namely, the microwave is used as a source of heat in the heat treatment of the mixture solution.

### Effect of the Invention

The magnetic particle of the present invention comprises the polymer shell portion provided on the surface of the core particle having a magnetism, so that the surface area of the magnetic particle is increased by the surface roughness which the polymer shell portion itself has (hereinafter, “polymer shell portion” is referred to also as “rough polymer shell portion”). This means that magnetic particles of the present invention are not roughened by a hubbly form of core particles, but are roughened by a hubbly form of the polymer shell portion provided on each surface of the core particles. Particularly in the magnetic particle of the present invention, the polymer shell portion is provided in a continuous coating form on all or a part of the surface of the core particle, and the external surface of the polymer shell portion has a hubbly shape. Accordingly, a specific surface area per one particle of the present invention is increased, as compared with that of a smooth polymer-coated particle in which the coating of the polymer has no hubbly surface. As a result, in accordance with the magnetic particle of the present invention, it is possible to immobilize a larger amount of “substance or functional group capable of binding to the target substance” onto the surface thereof, which will lead to an achievement of an increase in a binding amount of the target substance with respect to the single particle. The increased binding amount of the target substance with respect to the single particle can improve an efficiency of separation and recovery of the target substance, which leads to an improved detection sensitivity per volume of one particle upon detecting the target substance.

In accordance with the particle of the present invention, the core portion occupying most of the particle has a magnetism. When compared with “conventional magnetic particles having such a structure that superparamagnetic sub-particles with their diameter being several nanometers to several tens of nanometers have precipitated in the porous polymer particulate material”, the present invention has an increased proportion of the magnetic substance based on the whole volume of the particle due to the rough polymer shell portion provided at the surface region of the particle. In other words, a magnetization loss attributed to the polymer portion having no magnetization is reduced and thus the magnetization amount of the particle is comparatively increased as a whole. Therefore, when the magnetic particles of the present invention are used, a rate of magnetic separation can be increased and thus a binding, a separation and a purification, a quantitative determination and the like of the target substance can be carried out in a shorter time. Particularly in accordance with the present invention, advantageous effects can be provided in that the proportion of the magnetic substance in the entire volume of the particle can be appropriately adjusted by adjusting the thickness of the rough polymer shell portion provided at the surface region of the particle (for example, the proportion of the magnetic substance in the entire volume of the particle can be increased by decreasing the thickness of the rough polymer shell portion.

In a case where the polymer coat layer additionally comprises the hydrophilic polymer coat portion, not only the particle of the present invention can be suitably used as a magnetic particle in the areas of medical science and bio-science in view of its magnetic characteristic and particle diameter, but also the particle of the present invention can exhibit an excellent dispersibility (i.e., degree of dispersion) and dispersion stability in an aqueous medium (e.g., buffer solution or ultra pure water) without using a surfactant. These excellent dispersibility and dispersion stability are attributed to the hydrophilic-polymer coating treatment which is performed after a re-dispersion treatment of the particles obtained from the rough-polymer coating treatment. The higher dispersion stability results in an improved rate of the reaction between the magnetic particle and the target substance in its use applications, and also it can ensure an enough time for the above reaction due to a less sedimentation of the particle.

Furthermore, in a case where the magnetic particle is made up of the spherical core particle, a structural magnetic anisotropy of the particle can be reduced, and a coercive force thereof can also be reduced. Accordingly, the present invention can provide such an advantageous effect that the magnetic particles have an excellent re-dispersibility after being magnetically collected so that they are capable of being re-used in the same application or the other applications in which case a bindability of the re-used particles to a biological substance is prevented from drastically decreasing. Especially when the magnetic particles are respectively made up of the spherical core particles having narrow particle diameter distribution, the dispersibility and sedimentary of the respective particles serving as bulk particles can become uniform. As a result, even in the case where any random parts of the bulk particles are utilized, they can have equivalent reactivity or bindability to the target substances.

As such, the magnetic functional particles according to the present invention can be suitable in terms of not only the use thereof, but also the preparation therefor.

### BRIEF DESCRIPTION OF THE DRAWINGS

FIG. 1 is an electron microscopic image of “coating polymer-roughened magnetic particle P1″ in Example 1.

FIG. 2 is an electron microscopic image of core particle r1 in Example 1 and Comparative Example 1.

FIG. 3 is an electron microscopic image of “polymer-coated magnetic particle R1″ in Comparative Example 1.

FIG. 4 is measurement results of “Evaluation of Magnetic Collection Properties”.

FIG. 5 is a SEM image of surface of particle P1′.

FIG. 6 is a SEM image of surface of particle P2′.

FIG. 7 is a SEM image of surface of particle r1'.

FIG. 8 is a SEM image of surface of particle r2′.

FIG. 9 is a SEM image of surface of particle R2′.

FIG. 10 is TEM images of the magnetic particles according to the present invention.

FIG. 11 is measurement results of “Evaluation of Magnetic Collection Properties”.

FIG. 12 is photographs each showing the results of “Evaluation of Dispersion Stability” wherein the left-sided photographs show the results for the case of magnetic particles P2′ and the right-sided photographs show the results for the case of magnetic particles P1′.

### BEST MODES FOR CARRYING OUT THE INVENTION

Hereinafter, the magnetic particles according to the present invention will be described in detail.

### (Structure of Magnetic Particle of the Present Invention)

The magnetic particles each comprises “core particle having a magnetism” and “polymer coat layer comprising a polymer shell portion in which a rough coating of polymer is provided on a surface of the core particle”. In other words, each of the magnetic particles of the present invention has a hubbly core-shell structure wherein a magnetic microparticle serves as a core portion thereof, and a rough coating of polymer is provided on the surface of the microparticle. It is particularly preferred that the whole surface of the microparticle is covered with the rough coating of polymer so that the coating of the polymer has a hubbly surface which is in a continuous aciniform (i.e., in a continuous form of bunches).

Due to the rough coating of polymer, each of the magnetic particles of the present invention has an increased specific surface area. The largeness of the specific surface area of the magnetic particle according to the present invention is achieved since the magnetic particle has a roughness attributed to the hubbly shape of the polymer shell portion provided on the surface of the core particle. In this regard, the measured value (m²/g) of the specific surface area of the magnetic particle is 1.5 to 500 times the calculated value (m²/g) of the specific surface area of the core particle when the core particle is regarded as “smooth perfect sphere”. This means that the measured value (m²/g) of the specific surface area of each magnetic particle with a coating of polymer is 1.5 to 500 times larger than the calculated value (m²/g) of the specific surface area of the core particle with no coating of polymer, such calculated value being based on the average diameter of the core particles wherein each core particle is regarded as “smooth perfect sphere”.

The magnetic particle of the present invention has a roughened surface attributed to the polymer coat layer (particularly attributed to “polymer shell portion”), so that the specific surface area of the particle is 1.5 to 500 times the specific surface area of a true spherical particle which has the same particle diameter and the same density as those of the core particle, the surface of the true spherical particle being a smooth surface. This means the following matters:
Each of the present particles having the core particle diameter “a” has the specific surface area which is 1.5 to 500 times larger than the specific surface area of a true spherical particle having the particle diameter “a” (and also having the same density as that of the core particle).
An average value of the specific surface areas of a plurality of the present particles (i.e. particles having the form of powder) having the average core particle diameter “a” is 1.5 to 500 times larger than the specific surface area of a true spherical particle having the particle diameter “a” (and also having the same density as that of the core particle).

In other words, given that the value of the specific surface area of the magnetic particle according to the present invention is expressed by “SP particle” (m²/g) and that the value of the specific surface area of the true spherical particle having the same particle diameter and the same density as those of the core particle is expressed by “SP core true sphere” (m²/g), they have the following relationship:

“SP particle”=1.5×“SP core true sphere” to 500×“SP core true sphere” (i.e. 1.5×“SP core true sphere”≦“SP particle”≦500×SP core true sphere“)

In a case of “SP particle”<1.5×“SP core true sphere” (i.e. “SP particle” being less than 1.5×“SP core true sphere”), the binding amount of the target substance per one particle will decrease, which leads to a decrease in the detected amount of the target substance bound to the particles as a whole. On the other hand, in a case of “SP particle”>500×“SP core true sphere” (i.e. “SP particle” being larger than 500×“SP core true sphere”), it becomes practically undesirable since the “nonspecific binding” where the substance other than the target substance binds to the particle is more likely to occur beyond necessity. The lower limit of “SP particle” is preferably 1.6×“SP core true sphere”, more preferably 1.7×“SP core true sphere”, still more preferably 1.8×“SP core true sphere”. While on the other hand, the upper limit of “SP particle” is preferably 100×“SP core true sphere”, more preferably 20×“SP core true sphere”, still more preferably 10×“SP core true sphere”. There may be some cases where the lower limit of “SP particle” is less than 1.5×“SP core true sphere”, and the upper limit of “SP particle” is more than 500×“SP core true sphere”, depending on the various conditions such as processing conditions of the rough coating treatment and the kind of the materials of the polymer shell portion and core particle.

With respect to the magnetic particles of the present invention, the polymer coat layer may comprise not only the polymer shell portion but also a hydrophilic polymer portion. In this case, each of the magnetic particles of the present invention comprises “core particle having magnetism”, “rough polymer shell portion which is provided as a first layer by subjecting the surface of the core particle to a rough-polymer coating treatment” and “hydrophilic polymer coat portion which is provided as a second layer by subjecting the core particle with the rough polymer shell portion to a hydrophilic-polymer coating treatment”. In particular, the rough polymer shell portion of the first layer is provided in a form of a thickened shell of the magnetic particle, and the surface roughness of the particle is achieved by this polymer shell. In other words, each of the magnetic particles of the present invention has a hubbly core-shell structure wherein a microparticle having magnetism serves as a core portion thereof, and a rough coating of polymer is provided on the surface of the microparticle. In this regard, the roughness (i.e., hubbly form) of the magnetic particle is substantially achieved by the first layer of the rough polymer shell portion even though the particle has the hydrophilic polymer coat portion.

Even in a case where the hydrophilic polymer coat portion is provided, each of the magnetic particles of the present invention has an increased specific surface area. Namely, the roughness of the magnetic particle with the first layer of the rough polymer shell portion and the second layer of the hydrophilic polymer coat portion is achieved by the first layer of the rough polymer shell portion. Specifically, the measured value (m²/g) of the specific surface area of the magnetic particle is 1.5 to 500 times the calculated value (m²/g) of the specific surface area of the core particle when the core particle is regarded as “smooth perfect sphere”. This means that the measured value (m²/g) of the specific surface area of each magnetic particle after the hydrophilic-polymer coating treatment is 1.5 to 500 times larger than the calculated value (m²/g) of the specific surface area of the core particle before the rough-polymer coating treatment, such calculated value being based on the average diameter of the core particles wherein each core particle is regarded as “smooth perfect sphere”.

In other words, even in a case where the magnetic particle has not only the first layer of the rough polymer shell portion serving to roughen the particle, but also the second layer of the hydrophilic polymer coat portion thereon, the specific surface area of the magnetic particle is 1.5 to 500 times the specific surface area of a true spherical particle which has the same particle diameter and the same density as those of the core particle, the surface of the true spherical particle being a smooth surface. This means the following matters:
Each of the present particles having the core particle diameter “a” has the specific surface area which is 1.5 to 500 times larger than the specific surface area of a true spherical particle having the particle diameter “a” (and also having the same density as that of the core particle).
An average value of the specific surface areas of a plurality of the present particles (i.e. particles having the form of powder) having the average core particle diameter “a” is 1.5 to 500 times larger than the specific surface area of a true spherical particle having the particle diameter “a” (and also having the same density as that of the core particle).
   Given that the value of the specific surface area of the magnetic particle with the rough polymer shell portion and the hydrophilic polymer coat portion on a surface thereof is expressed by “SP particle” (m²/g) and that the value of the specific surface area of the true spherical particle having the same particle diameter and the same density as those of the core particle is expressed by “SP core true sphere” (m²/g), they have the following relationship:

“SP particle”=1.5×“SP core true sphere” to 500×“SP core true sphere” (i.e. 1.5×“SP core true sphere”≦“SP particle”≦500×“SP core true sphere”)

As described above, in a case of “SP particle”<1.5×“SP core true sphere” (i.e. “SP particle” being less than 1.5×“SP core true sphere”), the binding amount of the target substance per one particle will decrease, which leads to a decrease in the detected amount of the target substance bound to the particles as a whole. On the other hand, in a case of “SP particle”>500×“SP core true sphere” (i.e. “SP particle” being larger than 500×“SP core true sphere”), it becomes practically undesirable since the “nonspecific binding” where the substance other than the target substance binds to the particle is more likely to occur beyond necessity. The lower limit of “SP particle” is preferably 1.6×“SP core true sphere”, more preferably 1.7×“SP core true sphere”, still more preferably 1.8×“SP core true sphere”. While on the other hand, the upper limit of “SP particle” is preferably 100×“SP core true sphere”, more preferably 20×“SP core true sphere”, still more preferably 10×“SP core true sphere”. There may be some cases where the lower limit of “SP particle” is less than 1.5×“SP core true sphere”, and the upper limit of “SP particle” is more than 500×“SP core true sphere”, depending on the various conditions such as the processing conditions of the rough-polymer coating treatment and the hydrophilic-polymer coating treatment, as well as the kind of the materials of the polymer coat layer and core particle.

As used in this description and claims, the term “specific surface area” of the magnetic particle, which corresponds to the measured value of the specific surface area of the magnetic particle with only the rough polymer shell portion, or not only the rough polymer shell portion but also the hydrophilic polymer coat portion, means a specific surface area determined by a specific surface area micropore distribution analyzer of BELSORP-mini (manufactured by BEL Japan Inc.), especially determined by BET method. In a precise sense, “measured value of specific surface area of magnetic particle” is measured one with respect to the coating polymer-roughened magnetic particle at a point in time before the immobilization of “substance to which a target substance can bind” or “functional group to which a target substance can bind”. For sake of simplicity, however, the measured value regarding the magnetic particle at a point in time after the immobilization may be used or regarded as the “measured value of specific surface area of magnetic particle”.

The magnetic particles of the present invention (i.e., the magnetic particles with only the rough polymer shell portion, or not only the rough polymer shell portion but also the hydrophilic polymer coat portion) have magnetic properties suitable to be used as magnetic separation particles or magnetic probes in the area of the biotechnology or life-science. Specifically, the magnetic particles each having the polymer coat layer have a saturation magnetization preferably in the range of 2 A·m²/kg(emu/g) to 100 A·m²/kg(emu/g), more preferably in the range of 20 A·m²/kg(emu/g) to 100 A·m²/kg(emu/g), still more preferably in the range of 40 A·m²/kg(emu/g) to 90 A·m²/kg(emu/g). In terms of the magnetic particles each having the spherically-shaped core particle, the saturation magnetization thereof is, for example, in the range of 4 A·m²/kg (emu/g) to 90 A·m²/kg (emu/g). When the saturation magnetization of the particles falls below the lower limit of the above range, a sensitivity of the particles to the magnetic field tends to decrease, and thereby the magnetic response of the particles decreases. On the other hand, when the saturation magnetization of the particles exceeds the upper limit of the above range, the particles may tend to magnetically aggregate in excess, and thereby the dispersibility of the particles becomes lower. The values of the saturation magnetization in the present description are those obtained, for example, by measuring the amount of magnetization when a magnetic field of 796.5 kA/m (10 kilo oersted) is applied using a vibration sample magnetometer (manufactured by Toei Kogyo Co., Ltd.).

The coercive force of the magnetic particles each having the polymer coat layer (i.e., the coercive force of the magnetic particle with only the rough polymer shell portion, or not only the rough polymer shell portion but also the hydrophilic polymer coat portion) is preferably in the range of 0.3 kA/m to 15.93 kA/m (3.8 Oe to 200 Oe), more preferably in the range of 0.79 kA/m to 15.93 kA/m (10 Oe to 200 Oe), still more preferably in the range of 1.59 kA/m to 11.94 kA/m (20 Oe to 150 Oe). In terms of the magnetic particles each having the spherically-shaped core particle, the coercive force thereof is preferably in the range of 0.399 kA/m to 6.38 kA/m (5 Oe to 80 Oe), more preferably in the range of 0.399 kA/m to 4.79 kA/m (5 Oe to 60 Oe). The magnetic particles may be magnetized to some extent depending on the magnetic field/magnetic flux applied during the magnetic collection. When the coercive force of the particles exceeds the upper limit of the above range, the aggregation force among the particles may increase excessively, and thereby the dispersibility of the particles becomes lower. On the other hand, when the coercive force of the particles falls below the lower limit of the above range, the kinds of the core particles to be used for the magnetic particles and also the preparation method of the core particles tend to be limited. The value of the coercive force as used in this description is a value of the applied magnetic field at which the magnetization amount becomes zero when the magnetic field is returned to zero after applying the magnetic field of 796.5 kA/m (10 kOe), and then gradually increasing the magnetic field in the reverse direction.

As long as the magnetic particles of the present invention have the above magnetic properties, the “core particles” used in the present magnetic particles may be any suitable particles or any suitable spherical particles. For example, it is preferred that the core particle is not a superparamagnetic particle but a ferromagnetic particle, such as a ferromagnetic oxide particle. The term “ferromagnetic” as used herein means such a property that may be substantially permanently magnetized in response to the magnetic field. The term “ferromagnetic oxide particle” as used herein means a metal oxide particle which corresponds to a particulate having a magnetic responsibility (i.e., sensitivity to the magnetic field). The phrase “having a magnetic responsibility” means a property having a sensitivity to the magnetic field/magnetic flux, such as being magnetized in response to an external magnetic field/magnetic flux attributed to magnets or the like, or being attracted by the magnets. Examples of the material for the ferromagnetic oxide may include, but not particularly limited to, any known metals such as iron, cobalt and nickel as well as alloys and oxides thereof. In particular, it is preferred that the ferromagnetic oxide particle is a ferromagnetic iron oxide particle since it has an excellent sensitivity to the magnetic field/magnetic flux. As the ferromagnetic iron oxide for such particle, various kinds of known ferromagnetic iron oxides may be used. Particularly, it is preferred that the ferromagnetic iron oxide is at least one kind of ferrite selected from the group consisting of maghemite (γ-Fe₂O₃), magnetite (Fe₃O₄), nickel zinc ferrite (Ni₁₋ₓZnₓFe₂O₄) and manganese zinc ferrite (Mn₁₋ₓZnₓFe₂O₄) since they have an excellent chemical stability. Among them, the magnetite (Fe₃O₄) is particularly preferred since it has a large amount of magnetization and an excellent sensitivity to the magnetic field/magnetic flux. Depending on the application or the surface treatment, magnetic metals such as iron and nickel or alloys thereof may also be suitably used.

Many of the magnetic particles which are frequently used in the area of the biotechnology have superparamagnetism. The reason for this is that the superparamagnetic particle has significantly small residual magnetization (remanent magnetization) and coercive force, and thus the superparamagnetic particles, even without being subjected to any particular treatment, rarely affects their re-dispersibility characteristic after the magnetic-collection operation. On the other hand, when a particle having a ferromagnetism, and thus exhibiting coercive force is used, such particle tends to cause a problem associated with magnetic aggregation unless a particular treatment is provided. That is, the ferromagnetism particle exhibiting the coercive force is hard to use. In general, the primary particle diameter at which the iron oxide (e.g., magnetite) exhibits the superparamagnetism is considered to be less than 20 nm. Thus, the particle having a larger primary diameter than that will exhibit ferromagnetism.

The core particles of the magnetic particles according to the present invention have a particle diameter (average particle diameter) in the range of about 5 nm to about 3 μm, more preferably in the range of about 5 nm to about 1 μm, still more preferably in the range of about 20 nm to about 500 nm, for example in the range of about 20 nm to about 400 nm. In a case where the particle diameter of the core particles falls below the lower limit of the above range, the desired magnetic properties tend to be hardly maintained. On the other hand, in a case where the particle diameter of the core particles exceeds the upper limit of the above range, a high dispersion stability of the particles-dispersed water or buffer solution tends to be hardly maintained. As used in this description, the term “particle diameter” substantially means an average of the particle diameters which are obtained by measuring the particle diameters passing through the gravity center thereof in all directions (for example, average of minimum diameter and maximum diameter passing through the gravity center thereof). The term “average of the particle diameters (i.e., average particle diameter)” in this description substantially means a particle diameter (particle size) calculated as a number average by measuring each particle diameter of 300 particles for example, based on a transmission-type electron micrograph or optical micrograph of the particles.

In a preferred embodiment, the core particle of each of the magnetic particles according to the present invention has a spherical shape. Namely, the shape of the core particle is generally spherical one as a whole wherein the ratio of the largest radius to the smallest radius thereof, each of which radius is obtained by measuring the distance from the gravity center to the outer circumference of the particle in various directions, is in the range of 1.0 to 1.3, preferably in the range of 1.0 to 1.25, and more preferably in the range of 1.0 to 1.2. Due to such particle shape with the above ratio of the largest radius to the smallest radius, a structural magnetic anisotropy of the particles (i.e., anisotropy attributable to the particle shape) becomes smaller, and thus the magnetic particles exhibit a lower coercive force. In other words, with respect to the spherical magnetic particles, not only a practically satisfactory dispersibility but also a practically satisfactory magnetic collectivity is achieved due to the structural magnetic anisotropy thereof. In a practical sense, it is difficult to three-dimensionally measure the above ratio (i.e., ratio of the largest radius to the smallest radius of the particle), such ratio is measured from an electron microscope image of the particles. As an analysis software for easily obtaining the ratio of the largest radius to the smallest radius of the particle, Image-Pro Plus (manufactured by Nippon Roper Co., Ltd.) is available, in which case a value obtained as “radius ratio” therefrom corresponds to the above ratio (i.e., ratio of the largest radius to the smallest radius of the particle).

In a case where the core particles of the magnetic particles respectively have a spherical shape, CV value (Coefficient of Variation) of the particle diameters thereof is in the range of 0.01% to 19%, preferably in the range of 0.1% to 18%, more preferably in the range of 0.1% to 17%. For example, the CV value regarding the spherical core particles may be in the range of 10% to 18% or 10% to 17%. The larger the CV value is, the larger the variation in the particle diameters becomes, which may cause the variation of the measurement results when the particles are used for analyzing the target substances. Thus, the larger CV value is not desired. Just as an example, the coefficient of variation of the particle diameters may be obtained for example by measuring the particle diameters of about three-hundreds of particles based on a transmission-type electron microscope image or optical microscope image of the particles, followed by statistically processing the measured data.

$$\begin{matrix}\begin{matrix}CV value ( \% ) = \frac{ \begin{matrix}Standard Deviation of \\ Particle Diameter Distribution\end{matrix}}{Average Particle Diameter} \times 100 \\ = \frac{S}{\overline{r}} \times 100\end{matrix} & ( Formula 1 ) \\ ( \begin{matrix}S \text{:} \begin{matrix}Standard Deviation of \\ Particle Diameter Distribution\end{matrix} = \sqrt{\frac{1}{N} {\sum }_{k = 1}^{N} {( {r}_{k} - \overline{r} )}^{2}} \\ \overline{r} \text{:} Average Particle Diameter = \frac{1}{N} {\sum }_{k = 1}^{N} {r}_{k} \\ {r}_{k} \text{:} Respective Diameters of Particles \\ N \text{:} Number of Particeles\end{matrix} ) & \end{matrix}$$

When the magnetic particles has spherical core particles whose distribution regarding the particle diameters is small, the dispersibility and sedimentary of the respective particles serving as bulk particles become uniform. As a result, even in the case of utilizing any random parts of the bulk particles, they can have equivalent reactivity or bindability to the target substances.

There is a structural magnetic anisotropy as a source of the coercive force. In this regard, the magnetic particles having spherical core particles can have lower structural magnetic anisotropy, and thus exhibit a lower coercive force. This leads to an achievement of an improved re-dispersibility after being magnetically collected, which is one of properties particularly required for the polymer-coated magnetic particles for use in biochemical applications.

According to the present invention, a polymer deposits or adheres to the surface of the core particle. That is, there is provided a polymer coat layer on the surface of the particle serving as the core and having magnetism in the magnetic particle of the present invention. The polymer coat layer is configured to have the polymer shell portion, or to have not only the polymer shell portion but also the hydrophilic polymer coat portion. The polymer coat layer is provided on the surface of the core particle due to a chemical bond between the polymer coat layer and the core particle. Due to the chemical bond between the polymer coat layer (especially, polymer shell portion) and the core particle, a continuous coating of the polymer coat layer is provided on at least part of the surface of the core particle. Namely, the polymer coat layer (especially, polymer shell portion) itself has a continuous form on the core particle such that it does not have void enabling an exposure of the surface of the core particle in the body thereof. In other words, according to the present invention, there exists no void as formed due to a physical bond (e.g., physical adsorption and magnetic adsorption) between the core particle surface and other substances, such void enabling a localized exposure of the surface of the core particle. More particularly, the polymer coat layer is provided on the whole surface of the core particle so that the core particle is surrounded by the polymer coat layer.

In a preferred embodiment of the magnetic particle, the chemical bonding of polymer coat layer with the core particle can contribute to more reduced polymer amount of the polymer shell portion. Specifically, the amount of the coating polymer of the magnetic particle, which may depend on the kinds of the raw material therefor, is preferably in the range of 0.5 to 50% by weight, more preferably in the range of 1 to 40% by weight, still more preferably in the range of 2 to 30% by weight, the most preferably in the range of 3 to 25% by weight, for example in the range of 5 to 20% by weight based on the total weight of the magnetic particle. When the polymer amount of the rough polymer shell portion exceeds the upper limit of the above range, the polymer tends to exist not only merely on the surface of a single core particle, but also exist among a plurality of core particles so that those particles form an aggregate. On the other hand, when the polymer amount of the rough polymer shell portion falls below the lower limit of the above range, the dispersibility caused by the existence of the polymer will decrease, and thereby a plurality of core particles tend to aggregate one another. The amount of the polymer in the magnetic particle can effectively contribute to the dispersibility and dispersion stability of the particle-dispersed water or buffer solution.

The present invention provides the magnetic particles (especially, surfaces of the magnetic particles) with roughness, by the polymer shell portion of the polymer coat layer. Namely, the magnetic particle of the present invention has a hubbly core-shell structure attributed to the surface roughness of the shell polymer which is provided at the surface region thereof (i.e., hubbly core-shell structure attributed to the polymer obtained from the rough-polymer coating treatment). It should be noted that the roughness of the magnetic particle is provided by the coating of the polymer, and that the core particle itself does not have rough surface.

To indicate the degree of the roughness, the present invention makes use of the specific surface area of the core particle (especially, specific surface area of the core particle when the core particle is regarded as a smooth perfect sphere) as an index therefor. Specifically, the degree of the roughness for the magnetic particle is expressed by comparing it with the specific surface area (m²/g) of the core particle assuming that the core particle is a smooth perfect sphere particle. In this regard, the measured value (m²/g) of the specific surface area of the magnetic particle is 1.5 to 500 times, for example 1.6 to 100 times, in some cases 1.7 to 20 times larger than the value (m²/g) of the specific surface area of the core particle when the core particle is regarded as a smooth perfect sphere. For instance regarding the case where only the polymer shell portion is provided in the polymer coat layer, the measured value (m²/g) of the specific surface area of the magnetic particle is about 1.7 to 7 times larger than the value (m²/g) of the specific surface area of the core particle when the core particle is regarded as a smooth perfect sphere. In another instance regarding the case where not only the polymer shell portion but also the hydrophilic polymer coat portion is provided in the polymer coat layer, the measured value (m²/g) of the specific surface area of the magnetic particle is about 1.7 to 4 times larger than the value (m²/g) of the specific surface area of the core particle when the core particle is regarded as a smooth perfect sphere.

The magnetic particle of the present invention comprises an aromatic vinyl backbone in a molecular structure of the polymer coat layer, especially in a molecular structure of the polymer shell portion. This is attributed to the raw material used in the polymer coating treatment. When an aromatic vinyl monomer is used as one of the raw materials for the rough-polymer coating treatment, there is provided the aromatic vinyl backbone in the molecular structure of the polymer coat layer, especially in the molecular structure of the polymer shell portion. While not wishing to be bound by any particular theory, the presence of the aromatic vinyl backbone in the molecular structure of the polymer shell portion can contribute to a desired surface roughness of the magnetic particle. Examples of the aromatic vinyl backbone include divinylbenzene backbones, divinylbenzene derivative backbones and a combination thereof.

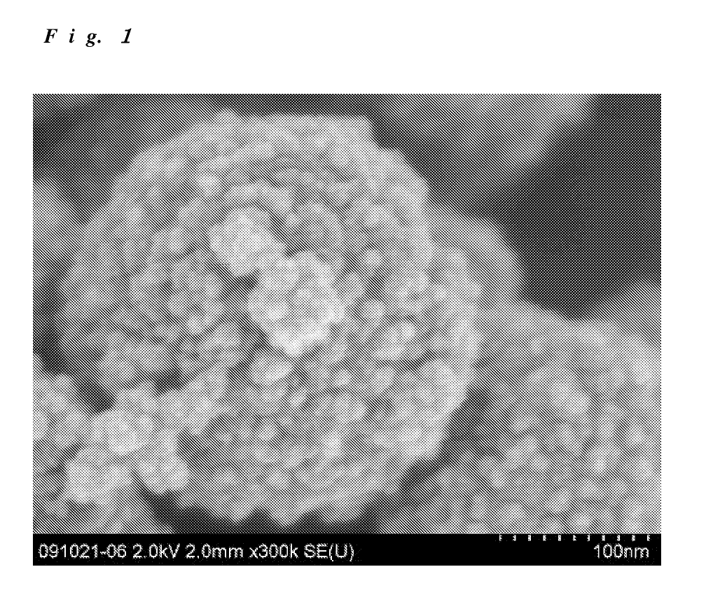

It is particularly preferred that the whole surface of the core particle is covered with the polymer shell portion (while preventing an exposure of the outer surface of the core particle), and that the polymer of the polymer shell portion has a hubbly surface. This means that the polymer shell portion surrounds the core particle such that the thickened layer of the polymer shell portion prevents the exposure of the core particle surface. The hubbly surface of the polymer layer has an aciniform, i.e., a form of bunches (preferably a continuous form of acini or bunches), for example. See FIG. 1 which will be referred later in Example. In some cases, the polymer shell portion is provided wholly on the surface of the core particle to have a hormogonal form, networklike form or spongelike aggregation form.

In a case where the hydrophilic polymer coat portion is additionally provided in the polymer coat layer, it is preferred that the hydrophilic polymer coat portion comprises at least one kind of hydrophilic group selected from the group consisting of carboxyl group, sulfonic acid group, sulfuric acid ester, hydroxyl group, ether group, amino group, betaine group and hosphorylcholine group. The presence of such hydrophilic groups in the polymer coat layer provides the magnetic particle with a hydrophilicity. The polymer amount of the hydrophilic polymer coat portion of the magnetic particle, which may depend on the kinds of the raw material therefor, is preferably in the range of 0.1 to 15% by weight, more preferably in the range of 0.2 to 10% by weight, still more preferably in the range of 0.5 to 5% by weight based on the total weight of the magnetic particle. As such, the polymer amount of the hydrophilic polymer coat portion is relatively much lower than that of the polymer shell portion. This means that the polymer shell portion composes a large part of the polymer coat layer, and thus the magnetic particle has roughness attributed to such polymer shell portion.

As described above, the magnetic particle of the present invention has the hubbly core-shell structure. In this regard, a thickness T_{polymer} of the hubbly polymer coat layer (especially, polymer shell portion) is preferably in the range of about 2 nm to about 500 nm, more preferably in the range of about 10 nm to about 100 nm on average (when the hubbly surface is averaged to be level). In other words, according to the magnetic particle of the present invention, the polymer coat layer (especially, polymer shell portion) continuously surrounds the core particle to have the average thickness of preferably about 2 nm to about 500 nm, more preferably about 10 nm to about 100 nm. In light of the diameter (average diameter) of the core particle (D_{core particle}) of preferably about 5 nm to about 3 μm, more preferably about 5 nm to about 1 μm, still more preferably about 20 nm to about 500 nm, the particle diameter (average diameter) D_{magnetic particle} of the magnetic particle having the polymer coat layer is in the range of preferably about 9 nm to about 4 μm, more preferably about 20 nm to about 1.2 μm, still more preferably about 40 nm to about 800 nm.

The magnetic particle of the present invention comprises “substance capable of binding to the target substance” and/or “functional group capable of binding to the target substance” immobilized on the surface of the core particle and/or the polymer coat layer. It is preferred that “substance capable of binding to the target substance” is at least one kind of a substance selected from the group consisting of biotin, avidin, streptavidin, neutravidin, protein A and protein G. It is preferred that “functional group capable of binding to the target substance” is at least one kind of a functional group selected from the group consisting of carboxyl group, hydroxyl group, epoxy group, tosyl group, sulfonic acid group, sulfuric acid ester group, succinimide group, maleimide group; sulfide functional groups such as thiol group, thioether group and disulfide group; aldehyde group, azido group, hydrazide group, primary amino group, secondary amino group, tertiary amino group, imide ester group, carbodiimide group, isocyanate group, iodoacetyl group, halogen-substitution of carboxyl group and double bond as well as derivatives thereof. In some cases, via a carboxyl group or amino group of the polymer coat layer, “substance capable of binding to the target substance” and/or “functional group capable of binding to the target substance” may be additionally formed on the surface, for example.

As used in this description, the term “immobilization (immobilized)” substantially means an embodiment wherein “substance to which a target substance can bind” or “functional group to which a target substance can bind” exists in the vicinity of the surface of the core particle and/or polymer coat layer. Namely, the term “immobilization (immobilized)” does not necessarily mean only the embodiment wherein “substance to which a target substance can bind” or “functional group to which a target substance can bind” is directly attached to the surface of the core particle and/or polymer coat layer. Also, the term “immobilization (immobilized)” substantially means an embodiment wherein “substance or functional group to which a target substance can bind” is immobilized on at least a part of the core particle and/or polymer coat layer. Accordingly, “substance or functional group to which a target substance can bind” is not necessarily immobilized over the entire surface of the core particle and/or polymer coat layer.

Since the magnetic particles of the present invention have the “substances or functional groups to which the target substances can bind” immobilized thereon, the target substances (i.e., the intended material) can bind to the particles via such substances or functional groups. As such, the particles of the present invention can be suitably used as magnetic separation particles or magnetic probes. As used in this description and claims, the expression “target substance can bind” includes not only an embodiment wherein a target substance is “chemically adsorbed” to particles, but also an embodiment wherein a target substance is “physically adsorbed” or “absorbed” to particles.

Preferably, the particles of the present invention have a density suited for separation and the like of a target substance. That is, the particles of the present invention have a density enabling a comparatively high sedimentation rate of the particles when the particles are dispersed in samples, for example, body fluids such as urine, blood, serum, plasma, sperm, saliva, sweat, tears, ascitic fluid and amniotic liquid of humans or animals; suspension liquids, extraction liquids, solutions or crushed solutions of organs, hair, skin, mucous membrane, nail, bone, muscle or nervous tissue of humans or animals; suspension liquids, extraction liquids, solutions or crushed solutions of stools; suspensions liquid, extraction liquids, solutions or crushed solution of cultured cells or cultured tissues; suspension liquids, extraction liquids, solutions or crushed solutions of virus; suspension liquids, extraction liquids, solutions or crushed solutions of fungus bodies; suspension liquids, extraction liquids, solutions or crushed solutions of soil; suspension liquids, extraction liquids, solutions or crushed solutions of plants; suspension liquids, extraction liquids, solutions, or crushed solutions of food and processed food; or drainage water. Specifically, the magnetic particles (each with polymer coat layer) of the present invention have the density preferably in the range of 1 g/cm³ to 9 g/cm³, more preferably in the range of 1 g/cm³ to 6 g/cm³. When the density of the particles is less than 1 g/cm³, only the spontaneous sedimentation of the particles will not bring about a preferable movement rate thereof from a practical standpoint. In contrast, the particle density of more than 9 g/cm³ is not preferred for a stirring operation upon binding of the target substance. In this regard, the density of the particles of the present invention is preferably in the range of 1 g/cm³ to 9 g/cm³, more preferably in the range of 1 g/cm³ to 6 g/cm³, still more preferably in the range of 3.5 g/cm³ to 7.0 g/cm³ (for example, 1.5 g/cm³ to 6 g/cm³). As used in this description, the term “density” means a true density (real density) in which only a volume occupied by the materials is used as a volume for calculation of density, and such density can be determined by a true density measuring device ULTRAPICNOMETER 1000 (manufactured by Yuasa Ionics Inc.).

### (Production Method of the Present Invention)

Next, the production method of the magnetic particles according to the present invention will be described.
(Method for Producing Magnetic Particle in which Only the Polymer Shell Portion is Provided in the Polymer Coat Layer)
The production method of the present invention preferably comprises the step of mixing precursor particles which will serve as core particles of the magnetic particles, a monomer and a solvent with each other, thereby chemically bonding a polymer component derived from the monomer with the precursor particles. Particularly in this step, the polymer shell portion of each magnetic particle, which is made of “chemically bonded polymer component”, is continuously formed on at least part of surfaces of the core particle to roughen the magnetic particle by the surface roughness of the polymer shell portion. The details of the method will be as follows:

For the production method of the present invention, commercially available particles can be used as “core particle having magnetism”. For example, Magnetite TM-023 (primary particle diameter: about 230 nm) manufactured by Toda Kogyo Corporation can be used.

First, core particles are preferably subjected to a silane coupling agent treatment so as to facilitate the formation of the polymer shell portion on the surfaces of the core particles. By subjecting the core particles to the silane coupling agent treatment, “polymerizable functional groups (e.g., double bond)” through which the polymer can bind to the surface of the particles are allowed to bind to the core particles. The silane coupling agent which has an acrylic group or methacrylic group on the end thereof may be used. There is no particular limitation on the kind of the solvent for the silane coupling agent treatment as long as the core particles can disperse therein and also the silane coupling agent can dissolve therein. However, the solvent is required to hydrolyze the silane coupling agent, and thus water is required even in a trace amount thereof. Therefore, a solvent capable of being miscible with water is preferable. Specifically, it is preferable to use, as the solvent, at least one selected from the group consisting of methanol, ethanol, tetrahydrofuran and water. In order to further promote the hydrolyzation of the silane coupling agent, an acid or an alkali may be added as a catalyst. For example, an acetic acid may be added as an acid catalyst, and an aqueous ammonia may be added as an alkali catalyst. The temperature during the reaction of the silane coupling agent and the core particles can be optionally selected, provided that it is neither below the melting point nor over the boiling point of the solvent to be used. The reaction time period can also be optionally selected, but it is however preferable to select in view of a reaction temperature.

After the silane coupling agent treatment is completed, it is preferable to remove the unreacted silane coupling agent by subjecting the particles to a washing treatment. Although there is no restriction on this washing treatment, a use of the centrifugation technique is simple and thus suitable. After the washing is completed, the core particles may be subjected to a dry treatment. This dry treatment may facilitate to form a chemical bond between the surfaces of the core particles and the silane coupling agent. Since there is also no particular restriction on this dry treatment, it may be performed at any suitable temperature. For example, a freeze-drying is preferable in order to prevent the aggregation of the particles upon the dry treatment. After the dry treatment is completed, it is required to re-disperse the particles (in this regard, there is also no particular restriction on this re-dispersion of the particles).

Then, the core particles whose surfaces have been treated with the silane coupling agent treatment are allowed to undergo a polymer coating treatment, i.e., a rough coating treatment. Specifically, the core particles, a monomer, a solvent and a polymerization initiator which is optionally used are mixed with each other, and thereby a polymer shell portion is formed on the surface of each core particle. Preferably, the continuous polymer shell portion is formed on the surface of each core particle through a chemical bond of the polymer shell portion with the core particle. It is preferred to use, as the monomer, a “low-molecular monomer having two or more polymerizable double bonds” and a “monomer capable of forming a coating”. It is possible to use them optionally in combination with a “polyethylene glycol chain compound having a polymerizable site at both ends or one end (for example, Light Acrylate commercially available from Kyoeisha Chemical Co., Ltd.)” and/or a “compound having a sulfonic acid group or sulfuric acid ester group, and having a polymerizable site at the end (for example, a monomer of styrenesulfonic acid or 2-acrylamide-2-methylpropanesulfonic acid)”.

While not wishing to be bound by any particular theory, it is considered that the roughening of the polymer can be suitably achieved since the monomer for forming the polymer shell portion contains the “low-molecular monomer having two or more polymerizable double bonds”. The “low-molecular monomer having two or more polymerizable double bonds” is preferably an aromatic vinyl monomer. Examples of the aromatic vinyl monomer include divinylbenzene monomer and/or divinylbenzene derivative monomer. While on the other hand, examples of the “monomer capable of forming a coating” include styrene, (meth)acrylic acid ester, (meth)acrylic acid amide, vinyl acetate, acrylonitrile, vinylether, vinylpyridine, vinylimidazole, vinyl pyrrolidone, a monomer having a target substance-binding functional group and the like.

The solvent for the polymerization may be, but not particularly limited to, at least one selected from the group consisting of water, methanol, ethanol and tetrahydrofuran. Furthermore, the polymerization initiator, which is optionally used as necessary, may be selected according to the kinds of the solvent. When the solvent is water or an alcohol-based solvent, for example, it is possible to use potassium persulfate, ammonium persulate, 2,2′-azobis(2-methylpropionamidine)dihydrochloride and/or a water-soluble azo polymerization initiators such as VA-044 or VA-061 (available from Wako Pure Chemical Industries, Ltd.). With respect to other initiators, taking some conditions such as hydrophilicity and hydrophobicity of the solvent to be used into consideration, thermal initiators such as azobisisobutyronitrile, benzoyl peroxide and dioctanoyl peroxide may be appropriately used, and a photoinitiator may also be used.

It is preferable to perform the rough-polymer coating treatment under such a condition that contains oxygen as little as possible. Thus, the roughening process using the polymer coating is carried out preferably in a reactor charged with the raw materials and also filled with nitrogen or argon gas. The temperature for the rough-polymer coating treatment (i.e., reaction temperature) can be optionally set according to a decomposition rate of the reaction initiator. There is no restriction on the time period (reaction time) for performing the rough-polymer coating treatment.

The rough-polymer coating treatment results in the magnetic particles having the deposited polymer provided on surfaces of the core particles thereof. Preferably, at least one part of the surface of each core particle is coated with the polymer shell portion having a continuous form, and thereby the magnetic particle has roughness due to the surface roughness of the polymer shell portion.

After the rough-polymer coating treatment is completed, the residual polymer which has not deposited to the particles or the unreacted raw monomers are removed from the particles by a washing treatment. Although there is no restriction on this washing treatment, the use of the centrifugation or magnetic separation techniques is simple and thus suitable.

The treatment for immobilizing a “target substance-binding substance” or “target substance-binding functional group” onto the surface of the polymer shell portion and/or core particle may be performed at any point in time before, during or after the rough-polymer coating treatment.

For example, in the case where the “target substance-binding functional group” is immobilized on the surfaces of the particles after the rough-polymer coating treatment, the magnetic particles are dispersed in the solvent, and then a compound having the functional group to be immobilized and the reaction catalyst are added to the resulting dispersion liquid under a warmed condition, followed by reacting them for several hours. This results in the immobilization of the “target substance-binding functional group” onto the surface of the polymer shell portion and/or core particle.

In the case where the immobilization of the “target substance-binding functional group” is performed upon the rough-polymer coating treatment, a monomer which contains “target substance-binding functional group” may be subjected to a polymerization process or a co-polymerization process. Examples of such monomer include (meth)acrylic acid, (meth)acryloyloxyalkylsuccinic acid, (meth) acryloyloxyalkylhexahydrophthalic acid, glycidyl (meth)acrylate, hydroxyalkyl (meth)acrylate, dimethylaminoalkyl (meth)acrylate, isocyanatoalkyl (meth)acrylate, p-styrenesulfonic acid (p-styrenesulfonate), dimethylolpropanoic acid, N-alkyldiethanolamine, (aminoethylamino)ethanol and lysine.

As for a case of the immobilization of the “target substance-binding substance”, a functional group having binding properties to the “target substance-binding substance” is preliminarily introduced onto the surface of the core particle body or the surface of the deposited polymer. Then, the “target substance-binding substance” can be immobilized to the particle via the preliminarily introduced functional group.

(Method for Producing Magnetic Particle in which not Only the Polymer Shell Portion but Also the Hydrophilic Polymer Coat Portion is Provided in the Polymer Coat Layer)

In a case of producing “magnetic particle in which not only the polymer shell portion but also the hydrophilic polymer coat portion is provided in the polymer coat layer”, first, the step (i) of the production method of the present invention is carried out. Specifically, the precursor particles which wound serve as the core particles of the magnetic particles are subjected to a rough-polymer coating treatment. Thereby, the polymer shell portion is formed on the surfaces of the precursor particles so that the particles are roughened. The term “rough polymer coating treatment” substantially means a treatment in which a coating of the particle with a polymer is performed so that the particle is roughened by the surface roughness of the polymer coating. Such treatment corresponds to one described in the above-mentioned “Method for producing magnetic particle in which only the polymer shell portion is provided in the polymer coat layer”.

An aromatic vinyl monomer (e.g., divinylbenzene etc.), which is a monomer used for the rough-polymer coating treatment, has hydrophobicity. Accordingly, after the rough-polymer coating treatment, the particles tend to have a form of aggregation in an aqueous solution. Moreover, the particles obtained from the rough-polymer coating treatment tend to chemically bond with each other to have an aggregated form by the coating polymer wherein not only one surface of each core particle but also a plurality of the core particles are wholly coated with the polymer. The resulting aggregated particles are likely to settle out in the aqueous solution due to the increased apparent diameter of the particles. Moreover, when a hydrophilic monomer is used in combination with the aromatic vinyl monomer (e.g., divinylbenzene etc.) so as to improve dispersibility, a certain degree of dispersibility of the particles is achieved in an aqueous solution. However, there is limitation to the degree of such dispersibility. A higher ratio of the hydrophilic monomer makes it difficult to provide a rough surface property, and thus a trade-off problem is caused.

As such, in order to effectively impart the hydrophilicity to the particles while maintaining the rough surface property of particles, the present invention subjects the particles to a re-dispersion treatment, especially a physical dispersion treatment which is performed as the step (i) after the rough-polymer coating treatment. In the physical dispersion treatment, it is preferable to apply an “external force which does not cause a fracture of the core particle and does not cause a severe peeling of the rough polymer shell portion” to the particles. The external force is preferably one originating in a mechanical shear force (e.g., high-speed shear force), a friction force, a compressive force, an ultrasonic wave and/or a shock wave.

As long as an improved monodispersibility of the particles after the rough-polymer coating treatment (i.e., treatment for forming a first layer) is achieved, any suitable physical dispersion treatments may be employed. Examples of the physical dispersion treatment include a co-agitation treatment with hard beads (e.g., zirconia beads) by using a mechanical stirrer; and also treatments by using a bath type ultrasonic wave, a probe type ultrasonic wave, a homogenizer, a jet mill, a paint shaker, a pico mill, a planetary ball mill and the like. The “homogenizer” as used herein corresponds to one as defined on page 525 in Chemical Engineering Dictionary (Kagaku Kogaku Jiten) (editor: Society for Chemical Engineers, Japan, publisher: Nobuo Suzuki, publishing office: Maruzen Company, Limited., Third Revised Edition). Namely, the term “homogenizer” as used in the present invention means not only a dispersing treatment means for dispersing the particles utilizing a shear force produced upon forcing the particles-containing fluid to pass through a narrow clearance gap under high pressure (for example, a means utilizing an impact due to high-speed rotation and a shear action due to vortex flow), but also a mechanical dispersing means such as a conventional mill (e.g., colloid mill, vibrating ball mill, agitating mill). As such, the “physical dispersion treatment” according to the present invention can also be referred to as “physical crushing treatment”. That is, the “physical dispersion treatment” includes a treatment embodiment wherein the aggregate state of the particles is released while applying an external force corresponding to a crushing force onto the particles.

Just as an example, a particles-containing fluid after the rough-polymer coating treatment (examples of fluid medium include aqueous medium such as water, ultra pure water and buffer solution) may be forced to pass through a slit (i.e., narrow clearance gap) under high pressure. Such passing of the fluid can cause a shear force to be applied to the particles, and thereby a dispersion action of the particles is provided. Such slit (thin gap) may be a “narrowed portion provided in a fluid passage” or “micro-opening formed in a disk provided on the way of a fluid passage”. The dimension (clearance gap dimension) of the slit is preferably in order of micron, and for example may be preferably in the range of 1 μm to 2 mm, more preferably in the range of 20 μm to 600 μm, and still more preferably in the range of 30 μm to 400 μm. The “high-pressure” may be one enabling a particles-containing fluid to pass through a slit. For example, the “high-pressure” is in the range of an atmospheric pressure (about 0.1 MPa) to 250 MPa, preferably in the range of 100 MPa to 230 MPa. For example, when a particles-containing fluid is forcibly supplied by using a pump (e.g., plunger pump), high-pressure and pressurization conditions can be generated. For example, the flow rate of the fluid passing through the slit is in the range of 50 m/s to 400 m/s, preferably in the range of 100 m/s to 200 m/s. If necessary, the particles-containing fluid to be treated may be divided into sub-fluids, and then such divided sub-fluids may be allowed to collide with each other in the slit.

Subsequent to the physical dispersion treatment, the step (ii) is carried out. Namely, the precursor particles from the rough-polymer coating treatment are subjected to a hydrophilic-polymer coating treatment, and thereby a hydrophilic polymer coat portion is formed on the precursor particle.

The term “hydrophilic-polymer coating treatment” substantially means a treatment in which a coating of the particle with a polymer is performed so that the particle is hydrophilized by the coating polymer.

According to a specific treatment operation, “core particles which each has the rough surface polymer shell portion”, a hydrophilizing monomer, a solvent and an optional polymerization initiator are mixed with each other. By using these raw materials, a hydrophilization of the particles is achieved. Examples of the hydrophilizing monomer include a monomer having a phosphorylcholine group, a betaine monomer such as methacryloyloxyethylcarboxybetaine, (meth)acrylic acid, (meth) acryloyloxyalkylsuccinic acid, (meth) acryloyloxyalkylhexahydrophthalic acid, glycidyl (meth)acrylate, hydroxyalkyl (meth)acrylate, dimethylaminoalkyl (meth)acrylate, isocyanate alkyl (meth)acrylate, p-styrenesulfonic acid (salt), dimethylolpropanoic acid, N-alkyldiethanolamine, (aminoethylamino)ethanol, lysin, “polyethylene glycol chain compound having a polymerizable site at both ends or one end thereof (for example, Light Acrylate commercially available from Kyoeisha Chemical Co., Ltd.)” and a “compound having a sulfonic acid group or sulfuric acid ester group, and a polymerizable site at one end thereof (for example, a monomer such as styrenesulfonic acid or 2-acrylamide-2-methylpropanesulfonic acid), and combination thereof.

The solvent for the hydrophilic-polymer coating treatment may be, but not particularly limited to, at least one selected from the group consisting of water, methanol, ethanol and tetrahydrofuran. Furthermore, the polymerization initiator, which is optionally used as necessary, may be selected according to the kinds of the solvent. When the solvent is water or an alcohol-based solvent, for example, it is possible to use potassium persulfate, ammonium persulate, 2,2′-azobis(2-methylpropionamidine)dihydrochloride and/or a water-soluble azo polymerization initiators such as VA-044 or VA-061 (available from Wako Pure Chemical Industries, Ltd.). As for the initiator, thermal initiators such as azobisisobutyronitrile, benzoyl peroxide and dioctanoyl peroxide may be appropriately used, and a photoinitiator may also be used.

The production method of the present invention comprises a treatment for immobilizing a “substance or functional group capable of binding to the target substance” onto particles. Such immobilization treatment may be carried out at any point in time before, during or after the rough-polymer coating treatment, or at any point in time before, during or after the hydrophilic-polymer coating treatment.

For example, in the case where the “target substance-binding functional group” is immobilized on the surfaces of the particles after the hydrophilic-polymer coating treatment, the magnetic particles are dispersed in the solvent, and then a compound having the functional group to be immobilized and the reaction catalyst are added to the resulting dispersion liquid under a warmed condition, followed by reacting them for several hours. This results in an immobilization of the “target substance-binding functional group” on the surface of the polymer coat layer and/or core particle.

In the case where the immobilization of the “target substance-binding functional group” is performed during the hydrophilic-polymer coating treatment, a monomer which contains “target substance-binding functional group” may be subjected to a polymerization process or a co-polymerization process. Examples of such monomer include (meth)acrylic acid, (meth) acryloyloxyalkylsuccinic acid, (meth) acryloyloxyalkylhexahydrophthalic acid, glycidyl (meth)acrylate, hydroxyalkyl (meth)acrylate, dimethylaminoalkyl (meth)acrylate, isocyanatoalkyl (meth)acrylate, p-styrenesulfonic acid (p-styrenesulfonate), dimethylolpropanoic acid, N-alkyldiethanolamine, (aminoethylamino)ethanol and lysine.

Next, the preparation of the magnetic core particle will be described. Firstly, as the step (I), an iron ion-containing solution and an alkaline solution are mixed with each other, and thereby allowing an iron element-containing hydroxide to precipitate in the resulting solution mixture. For example, an alkaline solution is added to the iron ion-containing solution. Thereby, an iron ion and an alkaline ion react with each other, and the resulting iron element-containing hydroxide enables it to precipitate in the solution mixture (such precipitated matter may also be referred to as a “deposited matter” or “coprecipitated matter”).

“Iron ion-containing solution” to be used in the step (I) is, for example, a solution obtained by dissolving an iron compound such as iron chloride, iron sulfate and iron acetylacetonato to a solvent capable of dissolving such iron compound. In this case, the iron ion is generally produced in the solution. Examples of the iron chloride include ferrous chloride (FeCl₂.4H₂O) and ferric chloride (FeCl₂. 6H₂O), and examples of the iron sulfate include ferrous sulfate (FeSO₄.7H₂O), and examples of the iron acetylacetonato include iron (II) acetylacetonato ((Fe (CH₃COCH═C(O) CH₃)₂). When any of the above compounds is dissolved in a solvent capable of dissolving the compound, the iron ion can be generated therein. The compound is dissolved in a solvent capable of readily dissolving the compound, and consequently the solvent is mixed with another solvent which hardly dissolve the compound, and thereby the resulting mixture may be used for the reaction. For example, it is preferred that after the iron sulfate is dissolved in a small amount of water, the resulting mixture is mixed with a polyhydric alcohol solvent such as glycerin. The glycerin contained in the solution serves to facilitate an isotropic growth of a crystal of the hydroxide (namely, the crystal grows to have a spherical shape). The concentration of the iron ion in the solution is preferably in the range of 0.03 to 6 mol/L, more preferably in the range of 0.06 to 3 mol/L. In order to obtain desired magnetic properties, cobalt ion, platinum ion and/or magnesium ion can be added to the solution as necessary.

The alkaline solution to be used in the step (I) is, for example, an solution obtained by dissolving an alkaline compound (e.g., NaOH, KOH, NH₃ or Tetramethylammonium hydroxide(N(CH₃)₄OH)) into a solvent capable of dissolving such compound. Therefore, alkali, which is contained in the alkaline solution, generally exists in the form of an ion. The concentration of the alkali in the alkaline solution is preferably in the range of 0.03 to 20 mol/L, and more preferably in the range of 0.06 to 10 mol/L. In this regard, it is preferred that the alkaline solution contains the alkali ion in an amount corresponding to the ionic valence of iron. It is particularly preferred that an alkali ion exists over the valence of iron ion. If the alkaline ion exists in larger amount than necessary, the number of water washing operation of the resulting ferromagnetic particles will increase, making the washing ineffective.

The temperature condition where an iron ion-containing solution is mixed with an alkaline solution is not particularly limited, but may be in the range of about 10° C. to about 90° C. (for example, normal temperature). The mixing operation may be performed under either an aerobic condition or an anaerobic condition. In terms of a simplified operation, the aerobic condition is preferred. There is no particular limitation on the pressure condition during the mixing treatment. For example, the mixing operation may be performed under an atmospheric pressure. With respect to the mixing of “iron ion-containing solution” and “alkaline solution”, it is preferable to agitate the iron ion-containing solution by an agitator such as a magnetic stirrer or three-one motor, while adding dropwise the alkaline solution by a dropping pump capable of dropping with constant rate.

As for the step (I), the alternative process is possible as follows: “Iron ion-containing solution” is used as a form of aqueous solution, and a compound having a lot of hydroxyl groups (e.g., polyvinyl alcohol and/or myo-inositol), not glycerin is added thereto as an agent for promoting “spheroidizing”. Thereafter, the alkali solution and then NaNO₃ serving as an oxidant are added to the resulting mixture, followed by a heating thereof. Also through such processes, a suitable promotion of “spheroidizing” can be achieved. In this regard, “Iron ion-containing solution” and the alkali solution are those as described above. The concentration of the compound having a lot of hydroxyl groups is preferably in the range of 0.03 to 6 mol/L, and more preferably in the range of 0.06 to 3 mol/L. As the oxidant, any suitable ones may be used as long as they have an oxidizing ability. As such, NaNO₃ and KNO₃ can be suitably used as the oxidant. The concentration of the oxidant is preferably in the range of 0.03 to 4 mol/L, and more preferably in the range of 0.06 to 1 mol/L.

Subsequent to the step (I), the step (II) is carried out. In the step (II) of the preparation according to the present invention, the aqueous solution mixture obtained from the step (I) is subjected to a heat treatment. The heat treatment may be performed while blowing air into the aqueous solution mixture using an air pump as necessary. It is preferred that the heating temperature of the step (II) is in the range of 70 to 300° C. There is no particular limitation on the pressure condition during the heat treatment. Thus, the heat treatment may be performed under atmospheric pressure or under a high pressure while heating the pressure container over the boiling point of the solvent therein, which may be referred to as a hydrothermal reaction (or solvothermal reaction). There is also no particular limitation on the heating time period, and for example it may be in the range of 5 hours to 30 hours, preferably in the range of 8 hours to 25 hours. There is also no particular limitation on the heating means. For example, any suitable heating devices such as an oil bath, a mantle heater and a dryer may be used, and also another heating device using microwave may be used. With regard to the microwave, there is a limitation on the kind of the solvent to be used since it has to be suitable for the heating of the microwave irradiation. The irradiation of the microwave, however, can provide an advantageous effect in that the solution can be uniformly heated from the inside thereof because the solvent itself is heated. Examples of the heating device using microwave include MicroSYNTH manufactured by Milestone general company.

The heat treatment of step (II) makes it possible to dissolve the hydroxide and then generate the ferromagnetic iron oxide particles which preferably have spinel structure. Examples of the iron oxide particles having the spinel structure include, but not particularly limited to, magnetite (Fe₃O₄) particles, maghemite (γ-Fe₂O₃) particles, and an intermediate particles of magnetite and maghemite. Depending on the kind of the ions contained in the solution mixture to be subjected to the heat treatment, there can be obtained the above iron oxide particles which further comprise cobalt (Co), platinum (Pt), magnesium (Mg), zinc (Zn) and/or nickel (Ni). The elements such as cobalt, platinum, magnesium and zinc are effective for adjusting the coercive force of the particles. Especially, “addition of cobalt” to the magnetite particles is effective for increasing the coercive force whereas “addition of magnesium” thereto is effective for reducing the coercive force.

It is preferred that the particles formed or synthesized in the step (II) is subjected to washing, filtration and drying processes. The washing process of the resulting core particles makes it possible to remove the impurities from the surfaces thereof. The core particles are washed preferably with water, however may be washed with any suitable solvents capable of being soluble in water, for example alcohol solvents such as ethanol and methanol. The filtration process may be performed together with the washing process, and thereby a wash liquid can be removed from the core particles. The drying process of the core particles is not indispensable, and thus, if needed, may be optionally performed. In the case where the drying process is performed, it is preferred that the core particles are dried at a temperature, preferably ranging from 10 to 150° C., more preferably ranging from 40 to 90° C. The core particles may be dried with a dryer, however they may be dried by an air seasoning.

The steps (I) and (II) may be performed under either of an aerobic condition or an anaerobic condition. When the reaction is performed under the anaerobic condition, it is necessary to replace the atmosphere in the reactor or the solvent to be used with an anaerobic gas. As the anaerobic gas, various inert gases except for oxygen (e.g., nitrogen or argon) can be used. On the other hand, when the reaction is performed under the aerobic condition, it may be performed under open air.

Through the above steps of the preparation as described above, the core particles which each has spherical shape and magnetism can be obtained. It should be noted that the concentration of the alkali is the most contributing factor for forming a spherical shape among the other factors in the preparation process of the core particles. Therefore, the core particles each having a spherical shape can be suitably obtained by optimizing the conditions of the alkali concentration. The obtained core particles having spherical shape can be suitably used in the production method of the magnetic particles according to the present invention.

### (Magnetic Collectivity)

Now, “excellent magnetic collectivity in water”, which is also one of distinguishing features of the present invention, will be described in detail.

As an index of the magnetic collectivity of the magnetic particles in water, “change in light absorbance of the water dispersion” may be adopted. That is, the light absorbance measurement through a spectrophotometer can be used for understanding a magnetic collectivity of water dispersion. This is specifically explained as follows:

In a water dispersion which contains the magnetic particles of the present invention, the magnetic particles are dispersed therein so that the dispersion is colored with the color of the magnetic particles. When a magnet is brought to approach the dispersion from outside, then the particles with magnetized bodies are forced to gather around the magnet (i.e., the magnetic particles are collected near the magnet), thereby the dispersion becomes colorless as a whole. When the light absorbance is measured by means of a spectrophotometer, a high absorbance is shown at the initial dispersion state of the dispersion, while the light absorbance gradually becomes lower as the magnetic collection advances. As such (i.e., according to the degree of the lowered light absorbance), the magnetic collectivity of the particles can be perceived.

The magnetic particles of the present invention can exhibit a satisfactory magnetic collectivity. This may be quantitatively explained as follows:

When the magnetic particles (especially particles each having the polymer shell portion) contained in the water liquid (e.g., buffer water solution) are magnetically collected by a magnetic field of 0.36 T (for example under such a condition that the concentration of the magnetic particles is in the range of about 0.1 to 0.2 mg/mL), the time required for the relative light absorbance of the buffer water solution to become about 0.1 to about 0.2 is within about 60 seconds (in contrast to the initial value at point in time before the magnetic-collection operation being 1). As an example, in a case where a magnetic field of 0.36 T is applied to a water dispersion in which the concentration of magnetic particles is for example about 0.2 mg/mL, the relative light absorbance of the water dispersion (the absorbance of light at about 550 nm) can decrease from its initial value “1” to about “0.04” within about 60 seconds after the initiation of the magnetic collection.

In another case where the magnetic particle has the polymer shell portion and the hydrophilic polymer coat portion, when a magnetic field of 0.36 T is applied to a buffer water solution in which the concentration of magnetic particles is for example about 0.1 to 0.2 mg/mL, the relative light absorbance of the buffer water solution can decrease from its initial value “1” to “range of about 0.1 to 0.2” within about 3 minutes after the initiation of the magnetic collection. Just as an example regarding this, when a magnetic field of 0.36 T is applied to a dispersion of buffer water solution in which the concentration of magnetic particles made up of the spherical core particles is about 0.2 mg/mL, the relative light absorbance of the dispersion (the absorbance of light at about 550 nm) can decrease from its initial value “1” to about “0.07” in about 2 minutes after the initiation of the magnetic collection.

As used in this description, the term “buffer water solution” means a fluid having a buffering effect which is capable of canceling the pH change upon addition of an acid or a base. More particularly, the term “buffer water solution” means a liquid capable of keeping its pH at a nearly constant value thereof, as used usually in the area of the medical science or bio-science (for example, the buffer water solution is a physiological buffer saline (PBS) of phosphoric acid (pH 7.2).

The values of the light absorbance regarding the present invention are those obtained, for example, by using a bio-spectrophotometer U-0080D (manufactured by Hitachi High-Technologies Corporation). As the source of the magnetic field upon the magnetic collection, a magnet can be used in which case any suitable magnets such as a ferrite magnet, a samarium cobalt magnet, a neodymium magnet and an alnico magnet may be used. The value of the magnetic field “0.36 T” is, for example, one measured using Handy Teslameter Elulu DTM6100 (manufactured by Mytech Corporation). Upon measuring the intensity of the magnetic field using the above apparatus, a magnet is attached to a measurement cell, and then a sensor assembly is arranged so as to contact with a side-wall of the measurement cell. The tip of the sensor assembly is made contact with the bottom of the side-wall of the measurement cell. As a result, the value of the magnetic field applied to the dispersion can be suitably measured.

When the magnetic collection is performed in a practical use, a strong magnet such as the neodymium magnet, and the samarium cobalt magnet may be used in the application where an accelerated magnetic collecting is desired. In contrast, the ferrite magnet may be used in the application where a delayed magnetic collecting is desired. In another viewpoint, not the material, but the surface magnetic flux density of the magnet may be available as a guide. In such case, the larger the value of the surface magnetic flux density is, the higher the magnetic collecting velocity becomes. While on the other hand, the smaller the value of the surface magnetic flux density is, the lower the magnetic collecting velocity becomes. This value may be determined by the user depending on the intended use. In the practical use, it will be more easily appreciated to measure the intensity of the magnetic field within the measurement cell. In this regard, similar to the above, the higher the intensity of the magnetic field is, the higher the magnetic collecting velocity becomes, whereas, the lower the intensity is, the lower the magnetic collecting velocity becomes. Thus, the value of the intensity of the magnetic field may also be determined by the user depending on the intended use.

### (Dispersibility and Sedimentation Velocity)

The dispersibility and sedimentation velocity in the case of the magnetic particles in which the polymer shell portion and the hydrophilic polymer coat portion are provided will be described. The comparison of the particle having only the rough polymer coating of the first layer with the particle not only the rough polymer coating but also the hydrophilic polymer coating of the second layer can be done with LUMiFuge (dispersion stability evaluation apparatus, commercially available from L.U.M. GmbH, Germany). Upon the measurement with LUMiFuge, 0.5 mL of particle dispersion (particle concentration: 1 mg/mL) whose medium is aqueous one such as water and PBS buffer solution (phosphoric acid: 10 mM, NaCl: 150 mM, pH7.2) is subjected a process condition of the given rotation speed, for example. It is also possible to visually evaluate the state of the particle dispersion after leaving it to stand in the sample tube. According to the present invention, the particle not only the rough polymer coating but also the hydrophilic polymer coating of the second layer exhibits higher dispersibility as well as lower sedimentation velocity than those of the particle having only the rough polymer coating of the first layer.

It should be noted that the present invention as described above includes the following aspects:

First aspect: A magnetic particle to which a target substance can bind, comprising:

a core particle having magnetism;

a polymer coat layer comprising a polymer shell portion in which a rough coating of polymer is provided on a surface of the core particle;

wherein the magnetic particle has a roughness due to a surface roughness of the polymer shell portion;

a specific surface area (m²/g) of the magnetic particle is 1.5 to 500 times a specific surface area (m²/g) of the core particle when the core particle is regarded as a smooth perfect sphere; and

a substance or functional group capable of binding to the target substance is immobilized on the core particle and/or the polymer coat layer.

Second aspect: The magnetic particle according to First aspect, wherein the polymer shell portion is provided on the surface of the core particle due to a chemical bond between the polymer shell portion and the core particle, wherein a continuous coating of the polymer shell portion is provided on at least part of the surface of the core particle.
Third aspect: The magnetic particle First or Second aspect, wherein the polymer shell portion comprises an aromatic vinyl backbone.
Fourth aspect: The magnetic particle according to Third aspect, wherein the aromatic vinyl backbone is a divinylbenzene backbone and/or a divinylbenzene derivative backbone.
Fifth aspect: The magnetic particle according to any one of First to Fourth aspects, wherein the polymer coat layer further comprises a hydrophilic polymer coat portion.
Sixth aspect: The magnetic particle according to Fifth aspect, wherein the hydrophilic polymer coat portion is located outside of the polymer shell portion in the polymer coat layer.
Seventh aspect: The magnetic particle according to any one of First to Sixth aspects, wherein a particle diameter of the core particle is in the range of 5 nm to 3 μm.
Eighth aspect: The magnetic particle according to any one of First to Seventh aspects, wherein each core particle of the magnetic particles has a spherical shape wherein a ratio of the largest radius to the smallest radius regarding each core particle is in the range of 1.0 to 1.3.
Ninth aspect: The magnetic particle according to Eighth aspect, wherein Coefficient of Variation (CV value) with regard to the spherical core particles, which represents a distribution of their particle diameters, is not more than 18%.
Tenth aspect: The magnetic particle according to any one of First to Ninth aspects, wherein a saturation magnetization of the magnetic particle is in the range of 2 A·m²/kg to 100 A·m²/kg.
Eleventh aspect: The magnetic particle according to any one of First to Tenth aspects, wherein a coercive force of the magnetic particle is in the range of 0.3 kA/m to 15.93 kA/m.
Twelfth aspect: The magnetic particle according to any one of First to Eleventh aspects, wherein the substance capable of binding to the target substance is at least one kind of a substance selected from the group consisting of biotin, avidin, streptavidin, neutravidin, protein A and protein G; and/or

the functional group capable of binding to the target substance is at least one kind of a functional group selected from the group consisting of carboxyl group, hydroxyl group, epoxy group, tosyl group, succinimide group, maleimide group, thiol group, thioether group, disulfide group, aldehyde group, azido group, hydrazide group, primary amino group, secondary amino group, tertiary amino group, imide ester group, carbodiimide group, isocyanate group, iodoacetyl group, halogen-substitution of carboxyl group and double bond.

Thirteenth aspect: A method for producing the magnetic particle according to any one of First to Twelfth aspects, comprising the step of mixing a precursor particle which will serve as a core particle of the magnetic particle, a monomer and a solvent with each other, and thereby chemically bonding a polymer component derived from the monomer with the precursor particle; and

wherein a polymer shell portion of the magnetic particle, which is made of the chemically-bonded polymer component, is continuously formed on at least part of the surface of the core particle, and thereby roughening the magnetic particle by a surface roughness of the polymer shell portion.

Fourteenth aspect: The method according to Thirteenth aspect, wherein an aromatic vinyl monomer is used as the monomer, and thereby forming the polymer shell portion which comprises an aromatic vinyl backbone.
Fifteenth aspect: A method for producing the magnetic particle according to according to any one of Sixth to Twelfth aspects depending on Fifth aspect, comprising the steps of:

(i) subjecting a precursor particle which will serve as a core particle of the magnetic particle to a rough-polymer coating treatment, and thereby forming a polymer shell portion on a surface of the precursor particle;

(ii) subjecting the precursor particle from the rough-polymer coating treatment to a hydrophilic-polymer coating treatment, and thereby forming a hydrophilic polymer coat portion on the precursor particle; and

wherein the precursor particle is subjected to a physical dispersion treatment (physically-dispersing treatment) at a point in time between the step (i) and the step (ii).

Sixteenth aspect: The method according to Fifteenth aspect, wherein a shear force is applied to the precursor particle in the physical dispersion treatment.

Seventeenth aspect: The method according to Fifteenth or Sixteenth aspect, wherein a passing of the precursor particle through a slit under pressure is performed in the physical dispersion treatment.
Eighteenth aspect: The method according to any one of Fifteenth to Seventeenth aspects, wherein, in the step (i), the precursor particle, a monomer and a solvent are mixed with each other, and thereby chemically bonding a polymer component derived from the monomer with the precursor particle; and

upon the mixing of them, the polymer shell portion made of the chemically-bonded polymer component is continuously formed onto at least part of the surface of the core particle, and thereby roughening the magnetic particle by a surface roughness of the polymer shell portion.

### Examples

Hereinafter, various kinds of examples regarding the present invention will be explained. Especially, “Case (A) specialized in the magnetic particles each having the polymer coat layer with only the polymer shell portion”, “Case (B) specialized in the magnetic particles each having the polymer coat layer with not only the polymer shell portion but also the hydrophilic polymer coat portion” and “Case (C) specialized in the magnetic particles each made up of the spherically-shaped core particle” are separately explained. First the Case (A), and then the Case (B) and finally the Case (C) will be explained.

┌Case (A) Specialized in the Magnetic Particles Each having a Polymer Coat Layer with Only the Polymer Shell Portion┘

### <<Production of Particles>>

In Example 1 and Comparative Example 1, magnetic particles were produced in the following manner.

### Example 1

### (Silane Coupling Agent Treatment)

Magnetite TM-023 (primary particle diameter: 230 nm) manufactured by Toda Kogyo Corporation was used as core particles r1 having magnetism. The core particles r1 (1.7 g) were dispersed in 475 mL of methanol. 3-methacryloxypropyltrimethoxysilane (LS-3360, manufactured by Shin-Etsu Chemical Co., Ltd.) (25.5 mL) was added to the resulting dispersion, followed by stirring at 40° C. for 4 hours. After stirring, the dispersion was subjected to centrifugal separation and washing, and then the solvent was replaced by water. As a result, there were obtained magnetic particles having a silane coupling agent immobilized thereon.

### (Roughening of Coating Polymer)

10 mL of “solution of magnetic particles having the silane coupling agent immobilized thereon (40 mg/mL)” was added to 38 mL of water. While stirring the resulting dispersion, it was subjected to a nitrogen atmosphere by allowing a nitrogen gas to flow. Then, 2 mL of divinylbenzene (manufactured by Wako Pure Chemical Industries, Ltd.), 0.5 mL of styrene (manufactured by Wako Pure Chemical Industries, Ltd.), 1.6 mL of 0.25 mg/mL water suspension (manufactured by Wako Pure Chemical Industries, Ltd.) of HOA-MS (2-acryloyloxyethylsuccinic acid, manufactured by Kyoeisha Chemical Co., Ltd.) and 2 mL of methanol were added to the dispersion. After stirring it for a while, 40 mg of potassium persulfate was added and the resultant reaction was allowed to proceed under a nitrogen atmosphere at 80° C. for 5 hours. Thereafter, a washing process was carried out by a magnetic separation method. As a result, there were obtained magnetic particles P1 having the surface roughness attributed to the coating polymer provided thereon.

### Comparative Example 1

5 mL of “solution of magnetic particles having the silane coupling agent immobilized thereon (40 mg/mL)” obtained from Example 1 was dispersed into 43 mL of water. While stirring the resulting dispersion, it was subjected to a nitrogen atmosphere by allowing a nitrogen gas to flow. Then, 0.7 mL of acrylic acid (manufactured by Wako Pure Chemical Industries, Ltd.) and 35 μL of Light Acrylate 9EG-A (manufactured by Kyoeisha Chemical Co., Ltd.) were added to the dispersion. While stirring it for a while, 1.4 mg of 2,2′-azobis(2-methylpropionamidine)dihydrochloride (manufactured by Wako Pure Chemical Industries, Ltd.) was added and the resultant reaction was carried out under a nitrogen atmosphere at 70° C. for 5 hours. Thereafter, a washing process was carried out by a centrifugal separation method. As a result, there were obtained magnetic particles R1 having the coating polymer thereon.

### <<Measurement of Specific Surface Area>>

Using a specific surface area micropore distribution analyzer of BELSORP-Mini (manufactured by BEL Japan Inc.), a specific surface area of the particles P1 obtained from Example 1 was measured by a BET method. The results of the measurement revealed that the magnetic particles P1 of Example 1 had a specific surface area of 18.8 m²/g. In the same manner, the specific surface area of the magnetic particles R1 obtained from Comparative Example 1 was measured by the BET method. As a result, the specific surface area of the particles R1 was 6.0 m²/g.

In the light of the fact that the specific surface area of the core particles r1 (Magnetite TM-023, manufactured by Toda Kogyo Corporation) measured by the BET method was 7.4 m²/g, it was found that the specific surface area was increased from 7.4 to 18.8 m²/g by the roughening of the coating polymer in Example 1. Namely, there were obtained particles roughened by the polymer coat layer according to the present invention in Example 1. In contrast, an increase in the specific surface area was not recognized in Comparative Example 1. In other words, it can be understood that, when a roughening of the coating polymer with divinylbenzene is carried out, like Example 1, the surface area of the resulting particles can be effectively increased as a whole by the polymer shell portion provided on the surfaces of the core particles.

Herein, the specific surface area of the core particles r1 was calculated on the assumption that such particles were smooth perfect spheres each having a particle diameter of 230 nm. As a result, it was found that the core particles r1 had the specific surface area of 5.2 m²/g. Therefore, the specific surface area of 18.8 m²/g of the magnetic particles P1 from Example 1 having the surface roughness attributed to the coating polymer is 3.6 times larger than the specific surface area 5.2 m²/g of the core particles r1. In contrast, the specific surface area 6.0 m²/s of the magnetic particles R1 from Comparative Example 1 is merely 1.2 times larger than the specific surface area 5.2 m²/g of the core particles r1.

### <<SEM Observation>>

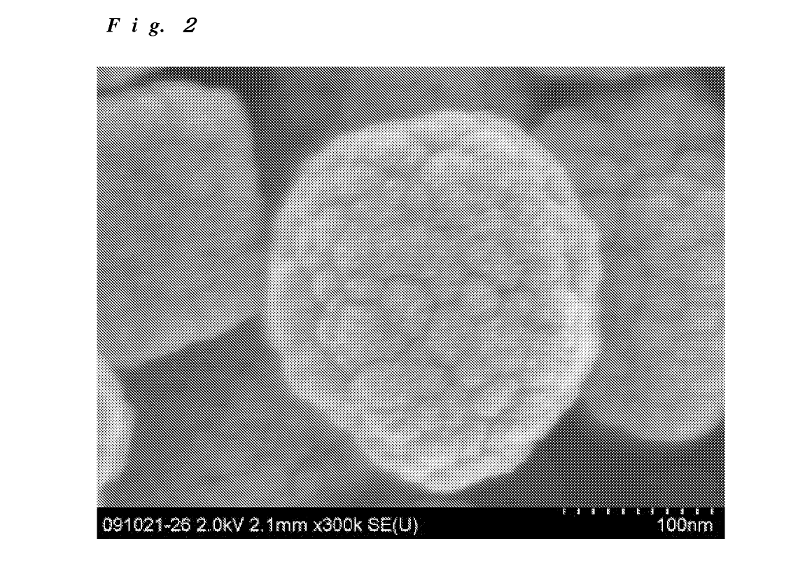

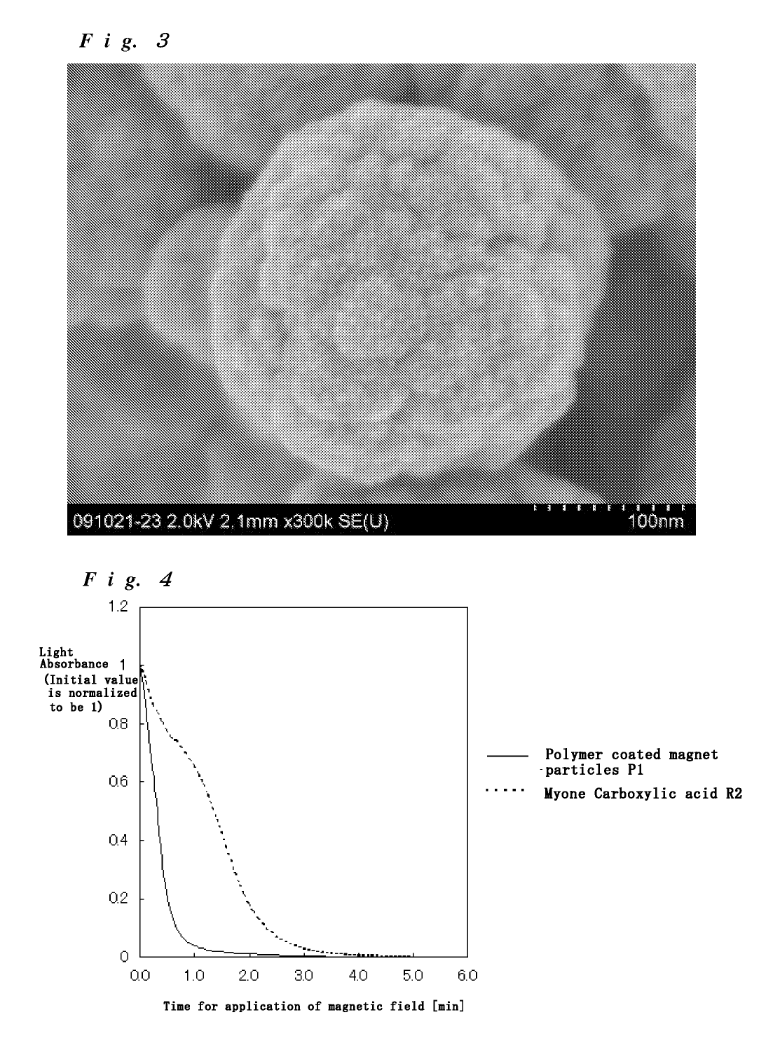

Surfaces of the magnetic particles P1 of Example 1, the core particles r1 and the magnetic particles R1 of Comparative Example 1 were observed. Specifically, surfaces of the magnetic particles P1, the core particles r1 and the magnetic particles R1 were observed using a scanning electron microscope. SEM images of surfaces of the particles P1, r1 and R1 are respectively shown in FIG. 1, FIG. 2 and FIG. 3.

As is apparent by referring to FIG. 1 to FIG. 3, the surface conditions of the particles of magnetic particles P1 (see FIG. 1) each having the surface roughness attributed to the coating polymer were clearly different from the surface conditions of particles of core particles r1 (see FIG. 2) and the surface conditions of particles of magnetic particles R1 (see FIG. 3) having the coating polymer. In this regard, the magnetic particles P1 each had rough polymer surface with a continuous aciniform (i.e., a form of continuous bunches).

### <<Measurement of Thermogravimetry>>

With respect to the magnetic particles P1 having the surface roughness attributed to the coating polymer and magnetic particles R1 having the coating polymer, the measurement of thermogravimetry (TG) was carried out. As a result, the polymer content of the magnetic particles P1 of Example 1 was 15.4% by weight (based on the total weight of particles), whereas the polymer content of the magnetic particles R1 of Comparative Example 1 was 2% by weight (based on the total weight of particles).

Considering the results of <<Measurement of Specific Surface Area>>, <<SEM Observation>> and <<Measurement of Thermogravimetry>> described above, it can be understood that magnetic particles P1 of Example 1 are roughened to have an aciniform (i.e., a form of bunches) by the polymer shell portion provided on surfaces of particles, resulting in an increase of the specific surface area of the particles.

### <<Immobilization Test of Biological Substance-Binding Substance>>

Streptavidin was immobilized to the magnetic particles P1 having the surface roughness attributed to the coating polymer and magnetic particles R1 having the coating polymer, respectively. The magnetic particles P1 and R1 were respectively subjected to the same treatment. The detailed explanation will be made by way of the magnetic particles P1 as an example.

First, the magnetic particles P1 (2 mg) was dissolved in 1 mL of 10 mM phosphate buffer (pH 7.2) to prepare 1 mL of magnetic particle liquid. Then, 1 mL of a solution obtained by dissolving 5 mg of DMT-MM (coupling agent, manufactured by Wako Pure Chemical Industries, Ltd.) in 1 mL of 10 mM phosphate buffer (pH 7.2) was added to the magnetic particle liquid to form 2 mL volume thereof, followed by application of ultrasonic wave for 5 minutes and further stirring at 1000 rpm for 25 minutes. After the magnetic separation, the resulting supernatant was removed and then 1 mL of 10 mM phosphate buffer (pH 7.2) was added. After the pipetting, an ultrasonic washing was carried out for 1 minute and the supernatant was removed by the magnetic separation. Such ultrasonic washing and magnetic separation were repeated once again, and then 10 mM phosphate buffer (pH 7.2) was added to form 1 mL volume of the liquid. As a result, there was obtained a carboxyl group-activated magnetic particle liquid.

Then, 1 mg of streptavidin (manufactured by Wako Pure Chemical Industries, Ltd.) was dissolved in 0.5 mL of 10 mM phosphate buffer (pH 7.2) and 0.5 mL of the carboxyl group-activated magnetic particle liquid was added, followed by application of ultrasonic wave for 1 hour. After stirring overnight using a rotator, a reaction for binding streptavidin to the carboxyl groups was accelerated. After the completion of the reaction, the resulting supernatant by the magnetic separation was removed, and 1 mL of 10 mM phosphate buffer (pH 7.2) was added. After pipetting and ultrasonic washing for 1 minute, the supernatant was removed by the magnetic separation. The unreacted activated carboxyl groups were hydroxylated by adding 1 mL of 0.2M Tris-HCl, applying ultrasonic wave for 1 minute and then stirring for 2 hours using a rotator. After the completion of the reaction, the supernatant was removed by the magnetic separation and 1 mL of 10 mM phosphate buffer (pH 7.2) was added. After pipetting and ultrasonic washing for 1 minute, the supernatant was removed by the magnetic separation. Such a washing operation was repeated twice again, 10 mM phosphate buffer (pH 7.2) was added to form 1 mL volume of the liquid. As a result, there was finally obtained a magnetic particle liquid in which the particles each had the immobilized streptavidin thereon.

### <<Evaluation Test of Specific Bindability>>

In order to evaluate the specific bindability of the streptavidin-immobilized magnetic particles and biotin, the binding amount of biotin regarding the streptavidin-immobilized magnetic particles was evaluated by using a biotinylated HRP. In the same manner as in the above-mentioned <<Immobilization Test of Biological Substance-Binding Substance>>, magnetic particles P1 and R1 were respectively subjected to the same treatment. The detailed explanation will be made by way of the magnetic particles P1 as an example.

First, in order to dilute 0.05 mg/mL of streptavidin-immobilized magnetic particles P1 with a PBS buffer solution, 0.25 mL of the PBS buffer solution was added to a 1.5 mL tube wherein the particles P1 was contained. The magnetic separation was carried out, and the resulting supernatant was removed. Thereafter, 100 μL of biotinylated HRP having the concentration of 100 ng/mL was added, followed by stirring for 30 minutes using a vortex mixer to allowed the biotinylated HRP to bind to the streptavidin-immobilized magnetic particles P1. The resulting particles were washed with 400 μL of a 10 mM PBS buffer solution (pH 7.2) in the tube and then was subjected to a magnetical separation treatment. Such washing was carried out four times in total. After removing the PBS buffer solution, 200 μL of TMB (tetramethylbenzidine) was added to the particles-containing tube, and the particle solution was allowed to develop a color by being left to stand for 30 minutes. Thereafter, 200 μL of 1N sulfuric acid was added to terminate the reaction. This reaction-terminated solution was diluted 5 times with 1N sulfuric acid and then 100 μL of the diluted solution was dispensed in well plates. The absorbance (450 nm) was measured by a plate reader Infinite 200 manufactured by TECAN Inc. and the color-developed amount of the particles charged in the tube was determined. The results are shown in Table 1.

TABLE 1

| | Light absorbance |
|---|---|
| | [—] |
| Example 1 | 0.89 |
| (Magnetic Particle P1) | |
| Comparative example 1 | 0.63 |
| Magnetic Particle R1) | |

Seen from the results shown in Table 1, it was confirmed that the magnetic particles P1 of Example 1 had larger bindability for biotin per unit weight of the particles as compared with that of magnetic particles R1 of Comparative Example 1.

In light of the above results, it can be understood that magnetic particles P1 having the surface roughness attributed to the coating polymer are capable of binding to a larger amount of target substance and thus can be suitably available as magnetic particles used in the area of the biotechnology or life-science.

### <<Evaluation of Magnetic Collection Properties>>

With respect to the magnetic particles P1 of Example 1 and Dynabeads manufactured by Invirogen Corporation (MyOne Carboxylic acid) R2 used as Comparative Example 2, the magnetism collection rate was measured in water. The magnetic particles P1 and R2 were respectively subjected to the same treatment. The detailed explanation will be made by way of magnetic particles P1 as an example. The saturation magnetization of magnetic particles P1 of Example 1 was 70.8 A·m²/kg and the coercive force thereof was 5.0 kA/m.

As a measuring device for evaluation of magnetism collection properties, bio-spectrophotometer U-0080D (manufactured by Hitachi High-Technologies Corporation) was used. Specifically, a dispersion liquid of the magnetic particles (0.2 mg/mL) was charged into a spectroscopic cell having 1 cm×1 cm square bottom, and the cell was placed in the spectrophotometer. After the particles were sufficiently dispersed by pipetting, a neodymium magnet NK037 (manufactured by Niroku Seisakusho) (outer size: 40 mm×20 mm×1 mm, surface magnetic flux density: 134 mT) was brought closer to the outside of the cell, and then the variation of the light absorbance at 550 nm was measured with time. The magnetic field inside of the cell in this case was measured by the above-mentioned method. As a result, the value of the magnetic field was 0.36 T.

FIG. 4 shows the results of the measurement. As seen from FIG. 4, the light absorbance had decreased in a short period of time in the case of the magnetic particles P1. Specifically, the relative light absorbance of the buffer solution in the case of the particles P1 had decreased from its initial value “1” to about 0.04 in about 60 seconds after the application of the magnetic field. In contrast, Dynabeads R2 manufactured by Invirogen Corporation required about 3 minutes for the same degree of the decrease in relative light absorbance.

In light of the results of FIG. 4, it was found that the magnetic particles P1 having the surface roughness attributed to the coating polymer according to the present invention could be effectively magnetically collected in a shorter period of time in the particles-containing dispersion.

┌Case (B) Specialized in the Magnetic Particles Each having a Polymer Coat Layer with not Only the Polymer Shell Portion but Also the Hydrophilic Polymer Coat Portion┘

### <<Production of Particles>>

In Example 1′ and Comparative Examples 1′ and 2′, magnetic particles were produced in the following manner.

### Example 1′

In Example 1′, the magnetic particles each with a rough-polymer coat layer and a hydrophilic polymer coat layer on the core particles thereof were produced.

### (Silane Coupling Agent Treatment)

Magnetite HM-305 (primary particle diameter: 210 nm) manufactured by Toda Kogyo Corporation was used as magnetic core particles r1′. After preliminarily dispersing a methanol-dispersed stock solution of the core particles r1′ (10 g/100 mL), methanol was added to 18 mL of the stock solution (corresponding to 1.8 g of core particles) to form 427 mL volume thereof, followed by a further preliminary dispersion thereof being carried out. 22.95 mL of 3-methacryloxypropyltrimethoxysilane (LS-3360, manufactured by Shin-Etsu Chemical Co., Ltd.) was added to the resulting dispersion, followed by stirring it at 40° C. for 4 hours. After stirring, the dispersion was subjected to centrifugal separation and washing, and then the solvent was replaced by water. As a result, there were obtained magnetic particles having a silane coupling agent immobilized thereon.

### (Rough-Polymer Coating Treatment)

59.96 mL of “preliminarily dispersed solution of magnetic particles having the silane coupling agent immobilized thereon (46.7 mg/mL)” (59.96 mL corresponding to “2.8 g” of “preliminarily dispersed magnetic particles having the silane coupling agent immobilized thereon) was added to 290 mL of water. While stirring the resulting dispersion, it was subjected to a nitrogen atmosphere by allowing a nitrogen gas to flow. Then, 5.25 mL of divinylbenzene (manufactured by Wako Pure Chemical Industries, Ltd.), 1.75 mL of styrene (manufactured by Wako Pure Chemical Industries, Ltd.), 1.75 mL of Light Acrylate 4EG-A (manufactured by Kyoeisha Chemical Co., Ltd.), 5 mL of 0.25 g/mL water suspension (manufactured by Wako Pure Chemical Industries, Ltd.) of HOA-MS (2-acryloyloxyethylsuccinic acid, manufactured by Kyoeisha Chemical Co., Ltd.) and 14 mL of methanol were added to the dispersion. After stirring it for a while, a solution produced by dissolving 142 mg of potassium persulfate in 7 mL of water was added and the resultant reaction was allowed to proceed under a nitrogen atmosphere at 80° C. for 5 hours. Thereafter, a washing process was carried out by a magnetic separation method. As a result, there were obtained rough-polymer-coated magnetic particles P1′.

### (Physical Dispersion Treatment and Hydrophilic-Polymer Coating Treatment)

17.8 mL of 21.32 mg/mL dispersion of the rough-polymer-coated magnetic particles P1′ (17.8 mL corresponding to 380 mg of rough-polymer-coated magnetic particles P1′) was added to 75 mL of water, followed by subjecting to a physical dispersion treatment. More specifically, the “dispersion to which water had been added” was forced to pass through a slit (thin gap) under pressure, and thereby a shear force was applied to the magnetic particles to form a dispersed state of the particles. While stirring the resulting dispersion, it was subjected to a nitrogen atmosphere by allowing a nitrogen gas to flow. Thereafter, 1.235 mL of acrylic acid (manufactured by Wako Pure Chemical Industries, Ltd.) and 66.5 μL of Light Acrylate 9EG-A (manufactured by Kyoeisha Chemical Co., Ltd.) were added, and also a solution produced by dissolving 66.5 mg of 2-acrylamide-2-methylpropanesulfonic acid in 5 mL of water was added. After stirring the dispersion for a while, a solution produced by dissolving 2.66 mg of 2,2′-azobis(2-methylpropionamidine)dihydrochloride (manufactured by Wako Pure Chemical Industries, Ltd.) in 5 mL of water was added and the resultant reaction was carried out under a nitrogen atmosphere at 70° C. for 5 hours. Thereafter, a washing process was carried out by a magnetic separation method. As a result, there were obtained hydrophilized rough-polymer-coated magnetic particles P2′ were obtained. In other words, particles P2′ each with the rough-polymer coat layer and the hydrophilic polymer coat layer on the core particle thereof were obtained.

### Comparative Example 1′

In Comparative Example 1′, magnetic particles each with the rough-polymer coat layer on core particle thereof were produced. In other words, magnetic particles, which had not been subjected to a hydrophilic polymer coating treatment, but had been only subjected to a rough-polymer coating treatment, were produced.

### (Silane Coupling Agent Treatment)

Magnetite TM-023 (primary particle diameter: 230 nm) manufactured by Toda Kogyo Corporation was used as core particles r2′ having magnetism. The core particles r2′ (1.7 g) were dispersed in 475 mL of methanol. 3-methacryloxypropyltrimethoxysilane (LS-3360, manufactured by Shin-Etsu Chemical Co., Ltd.) (25.5 mL) was added to the resulting dispersion, followed by stirring at 40° C. for 4 hours. After stirring, the dispersion was subjected to centrifugal separation and washing, and then the solvent was replaced by water. As a result, there were obtained magnetic particles having a silane coupling agent immobilized thereon.

### (Rough-Polymer Coating Treatment)

10 mL of “solution of magnetic particles having the silane coupling agent immobilized thereon (40 mg/mL)” was added to 38 mL of water. While stirring the resulting dispersion, it was subjected to a nitrogen atmosphere by allowing a nitrogen gas to flow. Then, 2 mL of divinylbenzene (manufactured by Wako Pure Chemical Industries, Ltd.), 0.5 mL of styrene (manufactured by Wako Pure Chemical Industries, Ltd.), 1.6 mL of 0.25 mg/mL water suspension (manufactured by Wako Pure Chemical Industries, Ltd.) of HOA-MS (2-acryloyloxyethylsuccinic acid, manufactured by Kyoeisha Chemical Co., Ltd.) and 2 mL of methanol were added to the dispersion. After stirring it for a while, 40 mg of potassium persulfate was added and the resultant reaction was allowed to proceed under a nitrogen atmosphere at 80° C. for 5 hours. Thereafter, a washing process was carried out by a magnetic separation method. As a result, there were obtained rough-polymer-coated magnetic particles R1′. In other words, the particles R1′ each having the rough-polymer coat layer, but having no hydrophilic polymer coat layer on the core particle thereof were obtained.

### Comparative Example 2′

In Comparative Example 2′, magnetic particles each with the hydrophilic polymer coat layer on core particle thereof were produced. Namely, the magnetic particles, which had not been subjected to a rough-polymer coating treatment, but had been only subjected to a hydrophilic polymer coating treatment, were produced.

### (Hydrophilic-Polymer Coating Treatment)

5 mL of “40 mg/mL solution of magnetic particles having a silane coupling agent immobilized thereon” obtained from the above Comparative Example 1′ was dispersed into 43 mL of water. While stirring the resulting dispersion, the dispersion was subjected to a nitrogen atmosphere by allowing a nitrogen gas to flow. Thereafter, 0.7 mL of acrylic acid (manufactured by Wako Pure Chemical Industries, Ltd.) and 35 μL of Light Acrylate 9EG-A (manufactured by Kyoeisha Chemical Co., Ltd.) were added. After stirring the dispersion for a while, 1.4 mg of 2,2′-azobis(2-methylpropionamidine)dihydrochloride (manufactured by Wako Pure Chemical Industries, Ltd.) was added and the resultant reaction was carried out under a nitrogen atmosphere at 70° C. for 5 hours. Thereafter, a washing process was carried out by a centrifugal separation method. As a result, there were hydrophilized-polymer coated magnetic particles R2′. In other words, the magnetic particles R2′ each having the hydrophilic polymer coat layer, but having no rough-polymer coat layer on the core particle thereof were obtained.

### <<Measurement of Specific Surface Area>>

Using a specific surface area micropore distribution analyzer of BELSORP-Mini (manufactured by BEL Japan Inc.), the specific surface areas of particles P1′ and P2′ obtained from Example 1′ were measured by a BET method. The results of the measurement revealed that the specific surface areas of the magnetic particles P1′ and P2′ of Example 1′ were respectively 28.7 m²/g and 15.9 m²/g. In the same manner, the specific surface area of the magnetic particles R2′ obtained from Comparative Example 2′ was measured by the BET method. As a result, the specific surface area of the particles R2′ was 6.0 m²/g. The specific surface areas of r1′, r2′ and R1′ were respectively 5.6 m²/g, 7.4 m²/g and 18.8 m²/g.

In light of the fact that the specific surface area of the core particles r1′ (manufactured by Toda Kogyo Corporation Magnetite HM-305) measured by the BET method was 5.6 m²/g, it was found that the specific surface area was increased from 5.6 to 28.7 m²/g by the rough-polymer coating in Example 1′. Namely, there were obtained particles which had been roughened by the polymer coat layer according to the present invention.

The specific surface area of the hydrophilized rough-polymer-coated magnetic particles P2′ was 15.9 m²/g. In this regard, the specific surface area had decreased from 28.7 m²/g of P1′ to 15.9 m²/g of P2′. It is conceivable that this decrease was caused by a peeling of the rough-polymer coat layer. However, since the specific surface area was larger than 5.6 m²/g of the core particles r1′, the peeling was just slight and thus the roughness of the particle surface was substantially maintained.

Herein, the specific surface area of the core particles r1′ was calculated on the assumption that the particles were smooth perfect spheres each having a particle diameter of 210 nm. As a result, it was found that the core particles r1′ had the specific surface area of 5.7 m²/g. Therefore, the specific surface area of 15.9 m²/g of the hydrophilized rough-polymer-coated magnetic particles P2′ of Example 1′ is 2.8 times larger than the specific surface area 5.7 m²/g of the core particles r1′. In contrast, the specific surface area 6.0 m²/s of the polymer-coated magnetic particles R2′ of Comparative Example 2′ is merely 1.2 times larger than the specific surface area 5.2 m²/g of the core particles r2′.

### <<SEM Observation>>

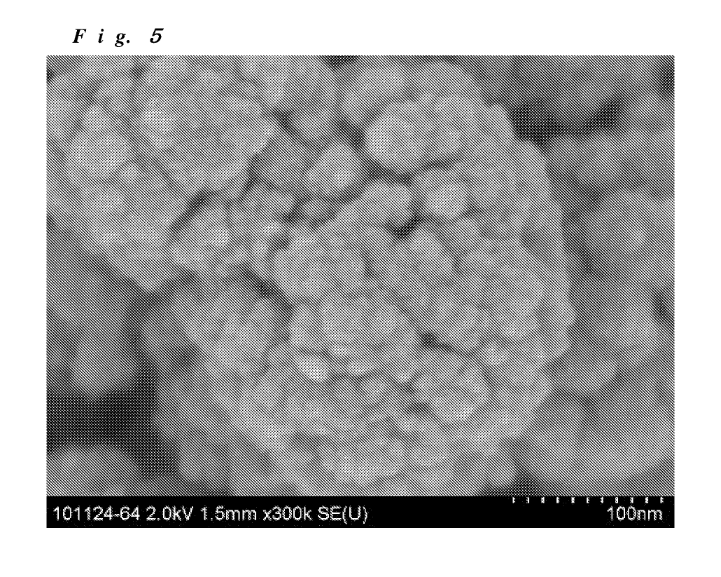

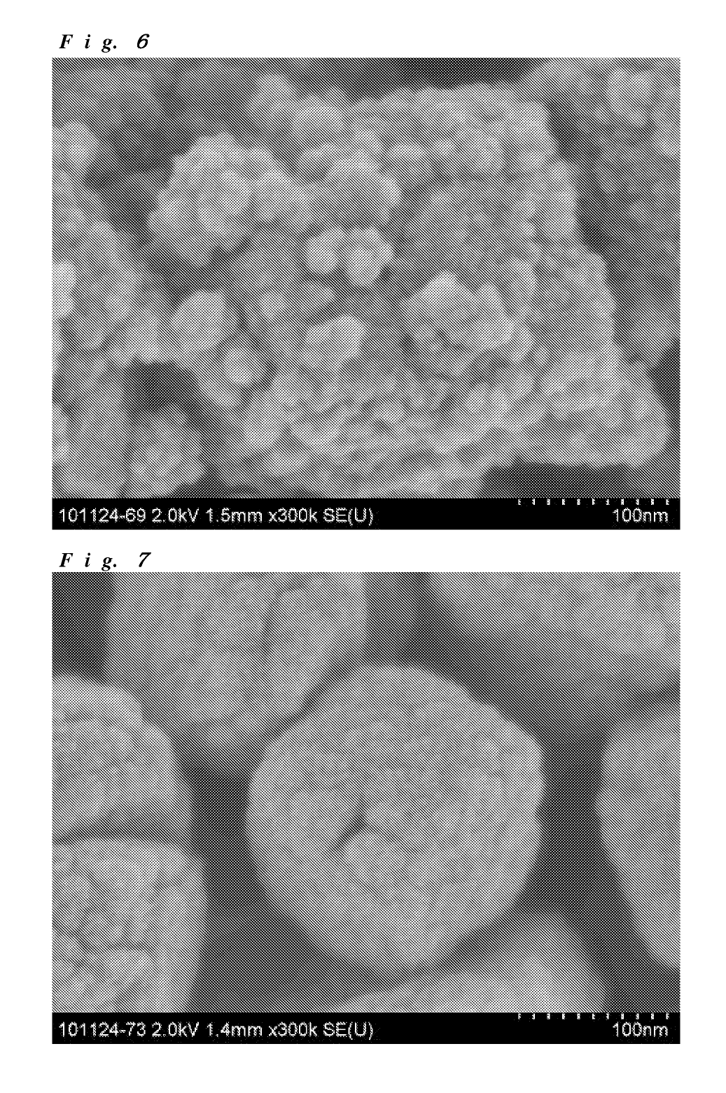

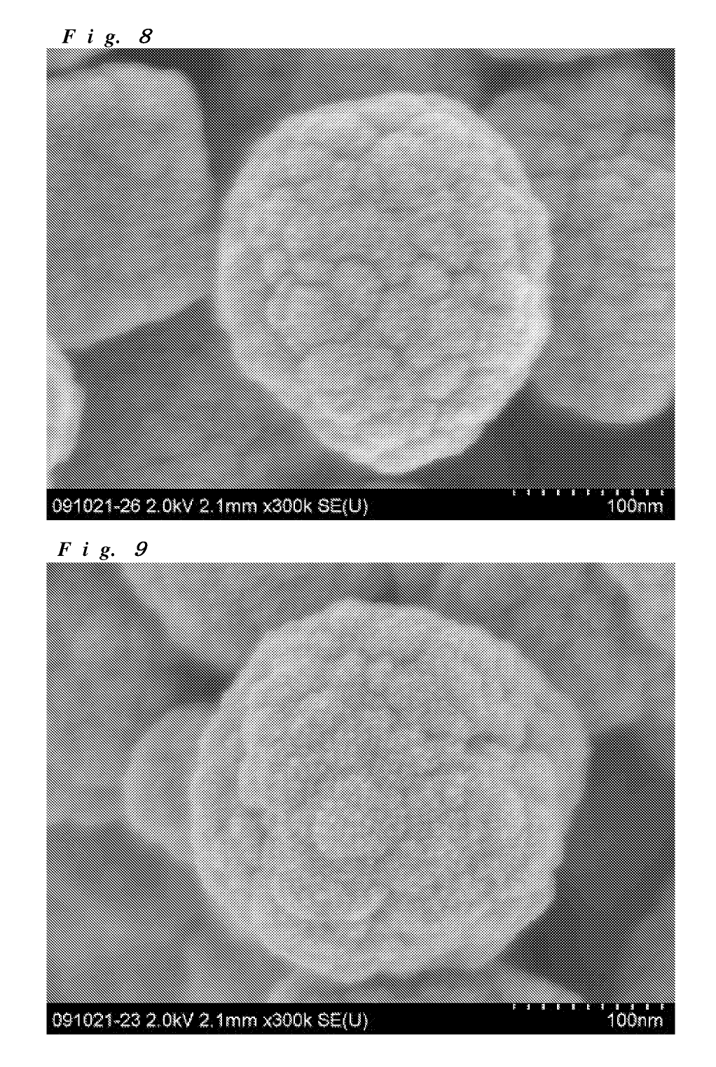

Surfaces of the magnetic particles P1′, P2′ and the core particles r1′ of Example 1′, the core particles r2′ of Comparative Example 1′ and the magnetic particles R2′ of Comparative Example 2′ were respectively observed. Specifically, surfaces of the magnetic particles P1′ and P2′, the core particles r1′ and r2′, and the magnetic particles R2′ were observed using a scanning electron microscope. The obtained SEM images of surfaces of the particles P1′, P2′, r1′, r2′ and R2′ are respectively shown in FIG. 5, FIG. 6, FIG. 7, FIG. 8 and FIG. 9.

As is apparent by referring to FIG. 5 to FIG. 9, the surface conditions of the rough-polymer-coated magnetic particles P1′ (see FIG. 5) were clearly different from those of the core particles r1′ (see FIG. 7) as well as the polymer-coated magnetic particles R2′ (see FIG. 9) of Comparative Example 2′. In this regard, the magnetic particles P1′ each had a rough polymer coating with a continuous aciniform (i.e., a form of continuous bunches) at the surface region thereof. It was also found that, even in the case of the hydrophilized rough-polymer-coated magnetic particles, surfaces of the particles had roughness (see FIG. 6).

### <<TEM Observation>>

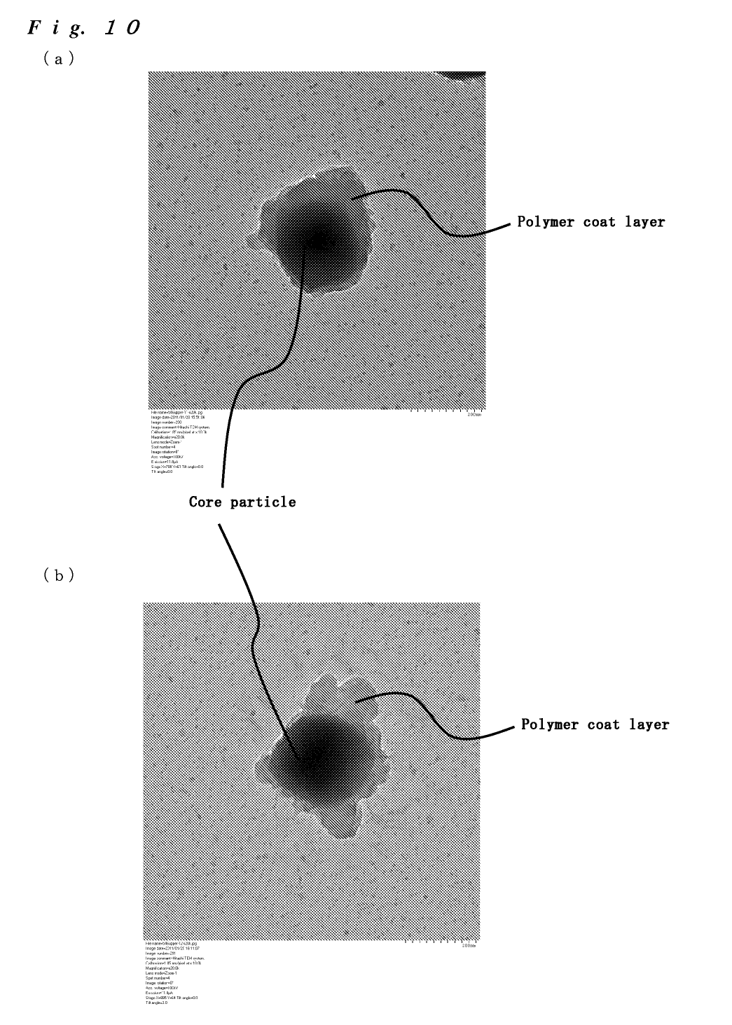

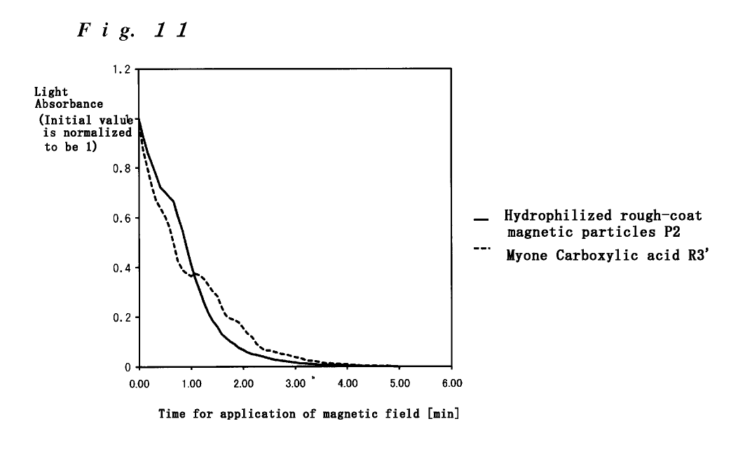

TEM images of magnetic particles obtained by produced in the same manner as in Example 1′ are shown in FIGS. 10(a) and 10(b). As is apparent from these TEM images, at least part of surface of each core particle is continuously coated with a polymer-coated layer (particularly, polymer shell portion) in the magnetic particle of the present invention. In other words, it was found that the polymer coat layer (particularly, polymer shell portion) itself provided on the core particle is continuously provided without including “void enabling a localized exposure of the surface of the core particle”. While not wishing to be bound by any particular theory, this was attributed to the main factor that the polymer coat layer (particularly, polymer shell portion) was provided on the surface of core particle due to a chemical bond of the polymer coat layer with the core particle.

### <<Measurement of Thermogravimetry>>

With respect to the rough-polymer-coated magnetic particles P1′, the hydrophilized rough-polymer-coated magnetic particles P2′, and the polymer-coated magnetic particles R1′ and R2′, the measurement of thermogravimetry (TG) was carried out. As a result, the polymer contents of the magnetic particles P1′ and P2′ from Example 1′ were respectively 44.2% by weight and 17.6% by weight (based on the total weight of particles), whereas the polymer content of the magnetic particles R1′ from Comparative Example 1′ was 15.4% by weight (based on the total weight of particles), and the polymer content of the magnetic particles R2′ from Comparative Example 2′ was 2% by weight (based on the total weight of particles).

Considering the results of <<Measurement of Specific Surface Area>>, <<SEM Observation>>, <<TEM Observation>> and <<Measurement of Thermogravimetry>> described above, it can be understood that the magnetic particles P1′ of Example 1′ and the magnetic particles R1′ of Comparative Example 1′ are roughened to have an aciniform (i.e., a form of bunches) by the polymer shell portion (particularly, polymer shell portion having a continuous form) coated on surfaces of particles, resulting in an increase of the specific surface area of the particles. Furthermore, it can be understood that, in the magnetic particles P2′ of Example 1′, the magnetic particles obtained by subjecting the rough-polymer-coated magnetic particles to the hydrophilic-polymer coating treatment similarly maintain the an acini-shaped roughness of the polymer shell portion, and thus the specific surface area of particles is kept increased as compared with that of the core particles.

### <<Immobilization Test of Biological Substance-Binding Substance>>

Streptavidin was immobilized to the rough-polymer-coated magnetic particles P1′, the hydrophilized rough-polymer-coated magnetic particles P2′ and the polymer-coated magnetic particles R2′. The magnetic particles P1′, P2′ and R2′ were respectively subjected to the same treatment. The detailed explanation will be made by way of magnetic particles P1′ as an example.

First, the magnetic particles P1′ (2 mg) were dissolved in 1 mL of 10 mM phosphate buffer (pH 7.2) to prepare 1 mL of a magnetic particle liquid. Then, 1 mL of solution obtained by dissolving 5 mg of DMT-MM (coupling agent, manufactured by Wako Pure Chemical Industries, Ltd.) in 1 mL of 10 mM phosphate buffer (pH 7.2) was added to the magnetic particle liquid to form 2 mL volume thereof, followed by application of ultrasonic wave for 5 minutes and further stirring at 1000 rpm for 25 minutes. After magnetic separation, the resulting supernatant was removed and 1 mL of 10 mM phosphate buffer (pH 7.2) was added. After pipetting, an ultrasonic washing was carried out for 1 minute and the resulting supernatant by magnetic separation was removed. Such ultrasonic washing and magnetic separation were repeated once again, and then 10 mM phosphate buffer (pH 7.2) was added to form 1 mL volume of the liquid. As a result, there was obtained a carboxyl group-activated magnetic particle liquid.

Then, 1 mg of streptavidin (manufactured by Wako Pure Chemical Industries, Ltd.) was dissolved in 0.5 mL of 10 mM phosphate buffer (pH 7.2) and 0.5 mL of the carboxyl group-activated magnetic particle liquid was added, followed by application of ultrasonic wave for 1 hour. After stirring overnight using a rotator, a reaction for binding streptavidin to the carboxyl groups was accelerated. After the completion of the reaction, the resulting supernatant by magnetic separation was removed, and 1 mL of 10 mM phosphate buffer (pH 7.2) was added. After pipetting and ultrasonic washing for 1 minute, the resulting supernatant by magnetic separation was removed. The unreacted activated carboxyl groups were hydroxylated by adding 1 mL of 0.2M Tris-HCl, applying ultrasonic wave for 1 minute and then stirring for 2 hours using a rotator. After the completion of the reaction, the resulting supernatant by magnetic separation was removed, and 1 mL of 10 mM phosphate buffer (pH 7.2) was added. After pipetting and ultrasonic washing for 1 minute, the resulting supernatant by magnetic separation was removed. Such a washing operation was repeated twice again, 10 mM phosphate buffer (pH 7.2) was added to form 1 mL volume of the liquid. As a result, there was finally obtained a magnetic particle liquid in which the particles each had the immobilized streptavidin thereon.

### <<Evaluation Test of Specific Bindability>>

In order to evaluate the specific bindability of the streptavidin-immobilized magnetic particles and biotin, the binding amount of biotin regarding the streptavidin-immobilized magnetic particles was evaluated by using a biotinylated HRP. In the same manner as in the above-mentioned <<Immobilization Test of Biological Substance-Binding Substance>>, the magnetic particles P1′, P2′ and R2′ were respectively subjected to the same treatment. The detailed explanation will be made by way of the magnetic particles P1′ as an example.

First, in order to dilute 0.05 mg/mL of streptavidin-immobilized magnetic particles P1′ with a PBS buffer solution, 0.25 mL of the PBS buffer solution was added to a 1.5 mL tube wherein the particles P1′ was contained. The magnetic separation was carried out, and the resulting supernatant was removed. Thereafter, 100 μL of biotinylated HRP having the concentration of 100 ng/mL was added, followed by stirring for 30 minutes using a vortex mixer to allowed the biotinylated HRP to bind to the streptavidin-immobilized magnetic particles P1′. The resulting particles were washed with 400 μL of a 10 mM PBS buffer solution (pH 7.2) in the tube and then was subjected to a magnetical separation treatment. Such washing was carried out four times in total. After removing the PBS buffer solution, 200 μL of TMB (tetramethylbenzidine) was added to the particles-containing tube, and the particle solution was allowed to develop a color by being left to stand for 30 minutes. Thereafter, 200 μL of 1N sulfuric acid was added to terminate the reaction. This reaction-terminated solution was diluted 5 times with 1N sulfuric acid and then 100 μL of the diluted solution was dispensed in well plates. The absorbance (450 nm) was measured by a plate reader Infinite 200 manufactured by TECAN Inc. and the color-developed amount of the particles charged in the tube was determined. The results are shown in Table 2 wherein the value of the absorbance was normalized based on standard particles.

TABLE 2

| | Light absorbance |
|---|---|
| | [—] |
| Example 1′ | 0.81 |
| (Magnetic Particle P1′) | |
| Example 1′ | 0.88 |
| (Magnetic Particle P2′) | |
| Comparative example 2′ | 0.63 |
| (Magnetic Particle R2′) | |

Seen from the results shown in Table 2, it was confirmed that the magnetic particles P2′ of Example 1′ had larger bindability for biotin per unit weight of the particles as compared with that of the magnetic particles R2′ of Comparative Example 2′.

In light of the above results, it can be understood that the hydrophilized rough-polymer-coated magnetic particles P2′ are capable of binding to a larger amount of target substance and thus can be suitably available as magnetic particles used in the area of the biotechnology or life-science.

### <<Evaluation of Magnetic Collection Properties>>

With respect to the magnetic particles P2′ of Example 1′ and Dynabeads manufactured by Invirogen Corporation (MyOne Carboxylic acid) R3′ used as Comparative Example 3′, the magnetism collection rate was measured in water. The magnetic particles P2′ and R3′ were respectively subjected to the same treatment. The detailed explanation will be made by way of magnetic particles P2′ as an example. The saturation magnetization of magnetic particles P2′ of Example 1′ was 69.5 A·m²/kg and the coercive force thereof was 5.0 kA/m.

As a measuring device for evaluation of magnetism collection properties, bio-spectrophotometer U-0080D (manufactured by Hitachi High-Technologies Corporation) was used. Specifically, a dispersion liquid of the magnetic particles (0.2 mg/mL) was charged into a spectroscopic cell having 1 cm×1 cm square bottom, and the cell was placed in the spectrophotometer. After the particles were sufficiently dispersed by pipetting, a neodymium magnet NK037 (manufactured by Niroku Seisakusho) (outer size: 40 mm×20 mm×1 mm, surface magnetic flux density: 134 mT) was brought closer to the outside of the cell and then the variation of the light absorbance at 550 nm was measured with time. The magnetic field inside of the cell in this case was measured by the above-mentioned method. As a result, the value of the magnetic field was 0.36 T.

FIG. 11 shows a graph of the measurement results. As is seen from FIG. 11, the relative light absorbance of the buffer solution in the case of the hydrophilized rough-polymer-coated magnetic particles P2′ had decreased from its initial value “1” to about 0.07 in about 2 minutes after the application of the magnetic field. The case of the Dynabeads R3′ manufactured by Invirogen Corporation exhibited the similar rate of the decrease in relative absorbance.

It can be understood from the results of FIG. 11 that, although a magnetic separation rate of magnetic particles in water dispersion may be generally lowered as the dispersion particle diameter decreases, the magnetic particles according to the present invention can maintain a capability of magnetic separation, in spite of the small diameter of the particles (i.e., the diameter of the core particles of the present magnetic particles being 210 nm and the dispersion particle diameter measured by DLS being about 500 nm).

### <<Evaluation of Dispersion Stability>>

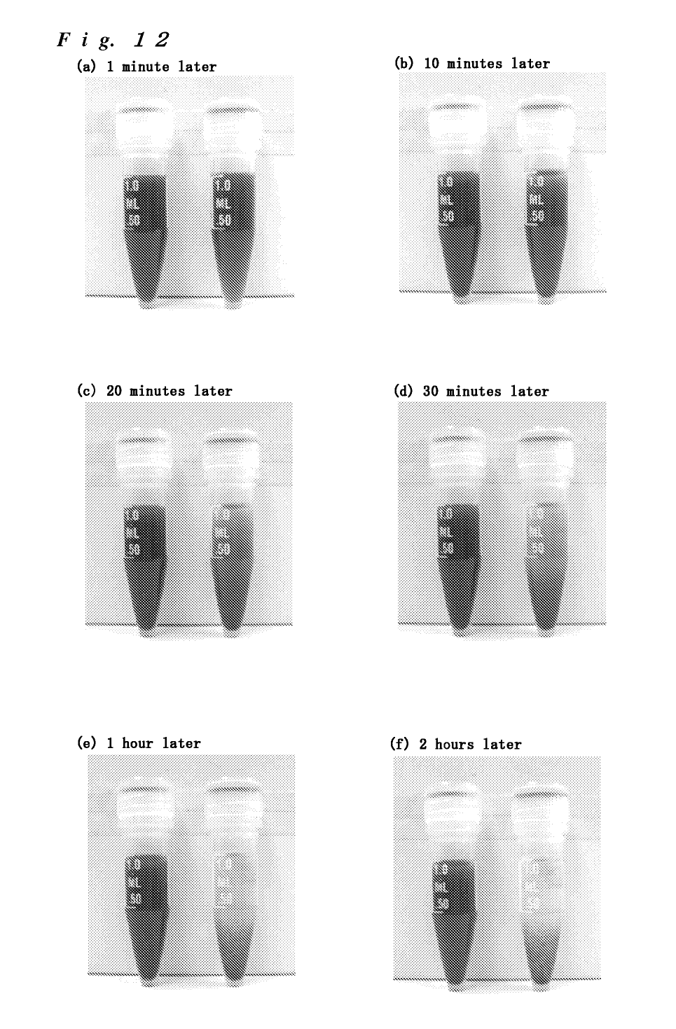

A comparison was made in terms of particle dispersibility in water between rough-polymer-coated magnetic particles P1′ and the hydrophilized rough-polymer-coated magnetic particles P2′. 1 mL of particle water dispersions (1 mg/mL) were respectively produced and the rate of the spontaneous sedimentation was visually observed. As indicated in the results shown in FIG. 12, the sedimentation of almost all the rough-polymer-coated magnetic particles P1′ was observed after 1 hour (right side), whereas the sedimentation was scarcely observed in the case of the hydrophilized rough-polymer-coated magnetic particles P2′ (left side). From this fact, it can be understood that the hydrophilized rough-polymer-coated magnetic particles P2′ are those which have a rough surface and has high dispersibility while maintaining excellent magnetic separation properties, and thus can be suitably available as magnetic particles used in the area of biotechnology or life-science.

┌Case (C) Specialized in the Magnetic Particles Each having a Spherically-Shaped Core Particle┘
Hydrophilic roughened magnetic particles each made up of a spherically-shaped core particle were produced in Example 1″, Hydrophilic roughened magnetic particles each made up of a nonspherically-shaped core particle were produced in Comparative example 1″, and magnetic particles each made up of a spherically-shaped core particle as well as having the hydrophilic polymer coat layer, but having no rough-polymer coat layer were produced in Comparative example 2″. Specific production processes are as follows:

### Example 1″

In Example 1″, the magnetic particles were produced through preparing the spherically-shaped core particles, followed by forming the rough-polymer coat layer and the hydrophilic polymer coat layer on the surface of each core particle.

### <Synthesis of Magnetite Particles>

As the reaction system, the anaerobic condition was adopted. Water and glycerin to be used as solvent were deaerated using nitrogen gas. During the reaction, the reactor was replaced with nitrogen gas, thereby no oxygen-condition was formed. The nitrogen gas with its purity of 99.998% was used.

Magnetite particles serving as the core particles were synthesized according to the procedures as follows:

First, 1.1 g ferrous sulfate (FeSO₄.7H₂O) was dissolved in 4 cc pure water to form an aqueous solution of ferrous sulfate. The resultant ferrous sulfate was mixed with 120 cc of glycerin to form a uniform solution. Apart from this, 112 g of sodium hydroxide was dissolved in 100 cc of pure water to form an aqueous solution of sodium hydroxide. Next, 14.7 cc of the aqueous solution of sodium hydroxide was added dropwise to the aqueous solution of ferrous sulfate while stirring the ferrous sulfate solution to form a precipitation of ferrous hydroxide. Water was added dropwise so as to adjust the final volume to be 145 cc. After this adding of water, the solution was stirred for 30 minutes. The resultant solution was introduced in a pressure-tight reactor and then reacted for 20 hours at a temperature of 180° C. by a dryer. The resultant particles were washed and then used for the next reaction without being dried. As a result, the resultant magnetite particles r1″ had almost spherical shapes having the ratio of the largest radius to the smallest radius of 1.14 and also had a primary particle diameter of 250 nm (the ratio of the largest radius to the smallest radius and the primary particle diameter of the magnetite particles were obtained as a number average of 300 particles after measuring each size thereof from a micrograph of transmission-type electron microscope using an image analyzing software Image-Pro Plus (manufactured by Nippon Roper Co., Ltd.) The magnetite particles had a saturation magnetization of 77.6 A·m²/kg (emu/g) and a coercive force of 3.10 kA/m (38.9 oersteds).

### (Silane Coupling Agent Treatment)

The magnetite particles r1″ obtained from the above reaction (200 mg) were dispersed in 50 mL of methanol. To the resulting dispersion liquid, 3 mL of 3-methacryloxypropyl trimethoxysilane (LS-3360, manufactured by Shin-Etsu Chemical Co., Ltd.) was added and stirred at 40° C. for 4 hours. Subsequently, the resulting suspension was subjected to a centrifugal treatment and washed, and then the solvent medium was replaced with water. As a result, there were obtained the magnetic particles Q1″ each having the silane coupling agent immobilized on the surface thereof.

### (Rough-Polymer Coating Treatment)

A 200 mg of the magnetic particles each having the silane coupling agent immobilized on the surface thereof were dispersed into 50 mL of water. While stirring the resulting dispersion, it was subjected to a nitrogen atmosphere by allowing a nitrogen gas to flow. Then, 0.375 mL of divinylbenzene (manufactured by Wako Pure Chemical Industries, Ltd.), 0.125 mL of styrene (manufactured by Wako Pure Chemical Industries, Ltd.), 0.125 mL of Light Acrylate 4EG-A (manufactured by Kyoeisha Chemical Co., Ltd.), 0.35 mL of 0.25 g/mL water suspension (Wako Pure Chemical Industries, Ltd.) of HOA-MS (2-acryloyloxyethylsuccinic acid, manufactured by Kyoeisha Chemical Co., Ltd.) and 2 mL of methanol were added to the dispersion. After stirring it for a while, a solution produced by dissolving 10 mg of potassium persulfate in 1 mL of water was added and the resultant reaction was allowed to proceed under a nitrogen atmosphere at 80° C. for 5 hours. Thereafter, a washing process was carried out by a magnetic separation method. As a result, there were obtained rough-polymer-coated magnetic particles P1″.

### (Physical Dispersion Treatment and Hydrophilic-Polymer Coating Treatment)

10 mL of 25 mg/mL dispersion of the rough-polymer-coated magnetic particles P1″ (10 mL corresponding to 250 mg of rough-polymer-coated magnetic particles P1″) was subjected to a physical dispersion treatment. Specifically, the dispersion was forced to pass through a slit (thin gap) under pressure, and thereby a shear force was applied to the magnetic particles to form a dispersed state of the particles. Thereafter, a washing process was carried out by magnetic separation method, and then water was added to the resulting dispersion to form a 50 mL volume thereof. While stirring the resulting dispersion, it was subjected to a nitrogen atmosphere by allowing a nitrogen gas to flow. Thereafter, 0.65 mL of acrylic acid (manufactured by Wako Pure Chemical Industries, Ltd.) and 35 μL of Light Acrylate 9EG-A (manufactured by Kyoeisha Chemical Co., Ltd.) were added, and also a solution produced by dissolving 35 mg of 2-acrylamide-2-methylpropanesulfonic acid in 1 mL of water was added. After stirring the dispersion for a while, a solution produced by dissolving 1.4 mg of 2,2′-azobis(2-methylpropionamidine)dihydrochloride (manufactured by Wako Pure Chemical Industries, Ltd.) in 1 mL of water was added and the resultant reaction was carried out under a nitrogen atmosphere at 70° C. for 5 hours. Thereafter, a washing process was carried out by a magnetic separation method. As a result, there were obtained hydrophilized rough-polymer-coated magnetic particles P2″ were obtained. In other words, particles P2″ only with the rough-polymer coat layer and the hydrophilic polymer coat layer on the core particle thereof were obtained.

### Comparative Example 1″

In Comparative example 1″, the magnetic particles were produced through forming the rough-polymer coat layer and the hydrophilic polymer coat layer on the surface of each of the nonspherically-shaped core particles.

### (Silane Coupling Agent Treatment)

Magnetite HM-305 (primary particle diameter: 210 nm) manufactured by Toda Kogyo Corporation was used as magnetic core particles r2″. After preliminarily dispersing a methanol-dispersed stock solution of core particles r2″ (10 g/100 mL), methanol was added to 18 mL of the stock solution (corresponding to 1.8 g of core particles) to form 427 mL volume thereof, followed by a further preliminary dispersion thereof being carried out. 22.95 mL of 3-methacryloxypropyltrimethoxysilane (LS-3360, manufactured by Shin-Etsu Chemical Co., Ltd.) was added to the resulting dispersion, followed by stirring it at 40° C. for 4 hours. After stirring, the dispersion was subjected to centrifugal separation and washing, and then the solvent was replaced by water. As a result, there were obtained magnetic particles Q2″ each having a silane coupling agent immobilized thereon.

A 59.96 mL of “preliminarily dispersed solution of magnetic particles having the silane coupling agent immobilized thereon (46.7 mg/mL)” (59.96 mL corresponding to “2.8 g” of “preliminarily dispersed magnetic particles having the silane coupling agent immobilized thereon) was added to 290 mL of water. While stirring the resulting dispersion, it was subjected to a nitrogen atmosphere by allowing a nitrogen gas to flow. Then, 5.25 mL of divinylbenzene (manufactured by Wako Pure Chemical Industries, Ltd.), 1.75 mL of styrene (manufactured by Wako Pure Chemical Industries, Ltd.), 1.75 mL of Light Acrylate 4EG-A (manufactured by Kyoeisha Chemical Co., Ltd.), 5 mL of 0.25 g/mL water suspension (manufactured by Wako Pure Chemical Industries, Ltd.) of HOA-MS (2-acryloyloxyethylsuccinic acid, manufactured by Kyoeisha Chemical Co., Ltd.) and 14 mL of methanol were added to the dispersion. After stirring it for a while, a solution produced by dissolving 142 mg of potassium persulfate in 7 mL of water was added and the resultant reaction was allowed to proceed under a nitrogen atmosphere at 80° C. for 5 hours. Thereafter, a washing process was carried out by a magnetic separation method. As a result, there were obtained rough-polymer-coated magnetic particles R1″.

### (Physical Dispersion Treatment and Hydrophilic-Polymer Coating Treatment)

17.8 mL of 21.32 mg/mL dispersion of the rough-polymer-coated magnetic particles R1″ (17.8 mL corresponding to 380 mg of rough-polymer-coated magnetic particles R1″) was added to 75 mL of water, followed by subjecting to a physical dispersion treatment. More specifically, the “dispersion to which water had been added” was forced to pass through a slit (thin gap) under pressure, and thereby a shear force was applied to the magnetic particles to form a dispersed state of the particles. While stirring the resulting dispersion, it was subjected to a nitrogen atmosphere by allowing a nitrogen gas to flow. Thereafter, 1.235 mL of acrylic acid (manufactured by Wako Pure Chemical Industries, Ltd.) and 66.5 μL of Light Acrylate 9EG-A (manufactured by Kyoeisha Chemical Co., Ltd.) were added, and also a solution produced by dissolving 66.5 mg of 2-acrylamide-2-methylpropanesulfonic acid in 5 mL of water was added. After stirring the dispersion for a while, a solution produced by dissolving 2.66 mg of 2,2′-azobis(2-methylpropionamidine)dihydrochloride (manufactured by Wako Pure Chemical Industries, Ltd.) in 5 mL of water was added and the resultant reaction was carried out under a nitrogen atmosphere at 70° C. for 5 hours. Thereafter, a washing process was carried out by a magnetic separation method. As a result, there were obtained hydrophilized rough-polymer-coated magnetic particles R2″. In other words, particles R2″ only with the rough-polymer coat layer and the hydrophilic polymer coat layer on the core particles thereof were obtained.

### Comparative Example 2″

In Comparative example 2″, the magnetic particles each with the hydrophilic polymer coat layer on the surface of the spherically-shaped core particle thereof were produced. Namely, the magnetic particles each made up of the spherically-shaped core particles which had not been subjected to a rough-polymer coating treatment, but had been only subjected to a hydrophilic polymer coating treatment, were produced.

### (Hydrophilic-Polymer Coating Treatment)

5 mL of “40 mg/mL dispersion of magnetic particles Q1″ having the silane coupling agent immobilized thereon” obtained from the spherically-shaped particles r1″ of the above Example 1″ was dispersed into 43 mL of water. While stirring the resulting dispersion, the dispersion was subjected to a nitrogen atmosphere by allowing a nitrogen gas to flow. Thereafter, 0.7 mL of acrylic acid (manufactured by Wako Pure Chemical Industries, Ltd.) and 35 μL of Light Acrylate 9EG-A (manufactured by Kyoeisha Chemical Co., Ltd.) were added. After stirring the dispersion for a while, 1.4 mg of 2,2′-azobis(2-methylpropionamidine)dihydrochloride (manufactured by Wako Pure Chemical Industries, Ltd.) was added and the resultant reaction was carried out under a nitrogen atmosphere at 70° C. for 5 hours reaction. Thereafter, a washing process was carried out by a centrifugal separation method. As a result, there were hydrophilized-polymer coated magnetic particles R3″. In other words, the magnetic particles R3″ each having the hydrophilic polymer coat layer, but having no rough-polymer coat layer on the core particles thereof were obtained.

### <<Immobilization Test of Biological Substance-Binding Substance>>

Streptavidin was immobilized to the hydrophilized rough-polymer-coated magnetic particles P2″ each made up of the spherically-shaped core particle, the hydrophilized rough-polymer-coated magnetic particles R2″ each made up of the nonspherically-shaped core particle, and the magnetic particles R3″ each made up of the spherically-shaped core particle as well as having the hydrophilic polymer coat layer, but having no rough-polymer coat layer. The magnetic particles P2″, R2″ and R3″ were respectively subjected to the same treatment. The detailed explanation will be made by way of magnetic particles P2″ as an example.

First, the magnetic particles P2″ (2 mg) were dissolved in 1 mL of 10 mM phosphate buffer (pH 7.2) to prepare 1 mL of a magnetic particle liquid. Then, 1 mL of a solution obtained by dissolving 5 mg of DMT-MM (coupling agent, manufactured by Wako Pure Chemical Industries, Ltd.) in 1 mL of 10 mM phosphate buffer (pH 7.2) was added to the magnetic particle liquid to form 2 mL volume thereof, followed by application of ultrasonic wave for 5 minutes and further stirring at 1000 rpm for 25 minutes. After magnetic separation, the resulting supernatant was removed, and 1 mL of 10 mM phosphate buffer (pH 7.2) was added. After pipetting, an ultrasonic washing was carried out for 1 minute and the resulting supernatant by magnetic separation was removed. Such ultrasonic washing and magnetic separation were repeated once again, and then 10 mM phosphate buffer (pH 7.2) was added to form 1 mL volume of the liquid. As a result, there was obtained a carboxyl group-activated magnetic particle liquid.

Then, 1 mg of streptavidin (manufactured by Wako Pure Chemical Industries, Ltd.) was dissolved in 0.5 mL of 10 mM phosphate buffer (pH 7.2) and 0.5 mL of the carboxyl group-activated magnetic particle liquid was added, followed by application of ultrasonic wave for 1 hour. After stirring overnight using a rotator, a reaction for binding streptavidin to the carboxyl groups was accelerated. After the completion of the reaction, the supernatant was removed by magnetic separation, and 1 mL of 10 mM phosphate buffer (pH 7.2) was added. After pipetting and ultrasonic washing for 1 minute, the resulting supernatant by magnetic separation was removed. The unreacted activated carboxyl groups were hydroxylated by adding 1 mL of 0.2M Tris-HCl, applying ultrasonic wave for 1 minute and then stirring for 2 hours using a rotator. After the completion of the reaction, the resulting supernatant by magnetic separation was removed, and 1 mL of 10 mM phosphate buffer (pH 7.2) was added. After pipetting and ultrasonic washing for 1 minute, the resulting supernatant by magnetic separation was removed. Such a washing operation was repeated twice again, 10 mM phosphate buffer (pH 7.2) was added to form 1 mL volume of the liquid. As a result, there was finally obtained a magnetic particle liquid in which the particles each had the immobilized streptavidin thereon.

### <<Evaluation Test of Specific Bindability>>

In order to evaluate the specific bindability of the streptavidin-immobilized magnetic particles and biotin, the binding amount of biotin regarding the streptavidin-immobilized magnetic particles was evaluated by using a biotinylated HRP. In the same manner as in the above-mentioned <<Immobilization Test of Biological Substance-Binding Substance>>, magnetic particles P2″, R2″ and R3″ were respectively subjected to the same treatment. The detailed explanation will be made by way of the magnetic particles P2″ as an example.

First, in order to dilute 0.05 mg/mL of streptavidin-immobilized magnetic particles P2″ with a PBS buffer solution, 0.25 mL of the PBS buffer solution was added to a 1.5 mL tube wherein the particles P2″ was contained. The magnetic separation was carried out, and the resulting supernatant was removed. Thereafter, 100 μL of biotinylated HRP having the concentration of 100 ng/mL was added, followed by stirring for 30 minutes using a vortex mixer to allowed the biotinylated HRP to bind to the streptavidin-immobilized magnetic particles P2″. The resulting particles were washed with 400 μL of a 10 mM PBS buffer solution (pH 7.2) in the tube and then was subjected to a magnetical separation treatment. Such washing was carried out four times in total. After removing the PBS buffer solution, 200 μL of TMB (tetramethylbenzidine) was added to the particles-containing tube, and the particle solution was allowed to develop a color by being left to stand for 30 minutes. Thereafter, 200 μL of 1N sulfuric acid was added to terminate the reaction. This reaction-terminated solution was diluted 5 times with 1N sulfuric acid and then 100 μL of the diluted solution was dispensed in well plates. The absorbance (450 nm) was measured by a plate reader Infinite 200 manufactured by TECAN Inc. and the color-developed amount of the particles charged in the tube was determined. The results are shown in Table 3 wherein the value of the absorbance was normalized based on standard particles.

TABLE 3

| | Light absorbance |
|---|---|
| | [—] |
| Example 1″ | 0.90 |
| (Magnetic Particle P2″) | |
| Comparative example 1″ | 0.88 |
| (Magnetic Particle R2″) | |
| Comparative example 2″ | 0.84 |
| (Magnetic Particle R3″) | |

Seen from the results shown in Table 3, it was confirmed that the magnetic particles P2″ of Example 1″ had “bindability for biotin per unit weight of the particles” equaling or surpassing those of the magnetic particles R2″ of Comparative Example 1″ and the magnetic particles R3″ of Comparative Example 2″.

In light of the above results, it can be understood that the hydrophilized rough-polymer-coated magnetic particles P2″ each made up of the spherically-shaped core particle are capable of binding to a larger amount of target substance and thus can be suitably available as magnetic particles used in the area of the biotechnology or life-science.

<<Evaluation of Dispersion Stability>>

A comparison was made in terms of dispersibility in water between the hydrophilized rough-polymer-coated magnetic particles P2″ each made up of the spherically-shaped core particle, the hydrophilized rough-polymer-coated magnetic particles R2″ each made up of the nonspherically-shaped core particle, and the magnetic particles R3″ each made up of the spherically-shaped core particle as well as having the hydrophilic polymer coat layer, but having no rough-polymer coat layer. 1 mg/mL water dispersions (1 mL) of the respective particles were respectively produced and the rate of the spontaneous sedimentation was visually observed. The slight sedimentation was observed after 2 hours in the case of the particles R2″ and the particles R3″. While on the other hand, the sedimentation was scarcely observed after 2 hours in the case of the particles P2″. From this fact, it can be understood that the hydrophilized rough-polymer-coated magnetic particles P2″ each made up of the spherically-shaped core particle are those which each has a rough surface and has high dispersibility while maintaining excellent magnetic separation, and thus can be suitably available as magnetic particles used in the area of biotechnology or life-science.

### INDUSTRIAL APPLICABILITY

The particles of the present invention can be used for a quantitative determination, separation, purification, analysis and the like of target substances such as cells, proteins, nucleic acids and chemical substances. For example, the particles of the present invention capable of binding to nucleic acids such as DNA can be used for analysis of DNA, and thus they contribute to tailor-made medical technologies.

When a substance capable of specifically binding to some biomaterial is immobilized on the surfaces of the particles of the present invention, such particles can be available for use in a simple isolation of only the targeted biomaterial wherein the particles and sample solution are mixed with each other, followed by the recovering of the particles. Accordingly, the particles of the present invention can be used in the applications not only in the test agent for extracorporeal diagnosis, but also in recovery or test of the biological materials such as DNA and protein in the medicinal and research areas. Furthermore, the particles of the present invention can be used in DDS (Drug Delivery System).

### CROSS REFERENCE TO RELATED PATENT APPLICATION

The present application claims the rights of priorities of Japan patent application No. 2010-202710 (filing date: Sep. 10, 2010, title of the invention: ROUGH-COATED FUNCTIONAL PARTICLE) and Japan patent application No. 2011-18409 (filing date: Jan. 31, 2011, title of the invention: ROUGH-COATED FUNCTIONAL PARTICLE WITH HIGH DISPERSIBILITY), the whole contents of which are incorporated herein by reference.

What is claimed is:

1. A magnetic particle to which a target substance can bind, comprising:
a core particle having magnetism;
a polymer coat layer comprising a polymer shell portion in which a rough coating of polymer is provided on a surface of the core particle;
wherein the magnetic particle has a roughness due to a surface roughness of the polymer shell portion;
a specific surface area (m²/g) of the magnetic particle is 1.5 to 500 times a specific surface area (m²/g) of the core particle when the core particle is regarded as a smooth perfect sphere; and
a substance or functional group capable of binding to the target substance is immobilized on the core particle and/or the polymer coat layer.

2. The magnetic particle according to claim 1, wherein the polymer shell portion is provided on the surface of the core particle due to a chemical bond between the polymer shell portion and the core particle, wherein a continuous coating of the polymer shell portion is provided on at least part of the surface of the core particle.

3. The magnetic particle according to claim 1, wherein the polymer shell portion comprises an aromatic vinyl backbone.

4. The magnetic particle according to claim 3, wherein the aromatic vinyl backbone is a divinylbenzene backbone and/or a divinylbenzene derivative backbone.

5. The magnetic particle according to claim 1, wherein the polymer coat layer further comprises a hydrophilic polymer coat portion.

6. The magnetic particle according to claim 5, wherein the hydrophilic polymer coat portion is located outside of the polymer shell portion in the polymer coat layer.

7. The magnetic particle according to claim 1, wherein a particle diameter of the core particle is in the range of 5 nm to 3 μm.

8. The magnetic particle according to claim 1, wherein the core particle has a spherical shape wherein a ratio of the largest radius to the smallest radius regarding the core particle is in the range of 1.0 to 1.3.

9. The magnetic particle according to claim 8, wherein Coefficient of Variation (CV value) with regard to the spherical core particles, which represents a distribution of their particle diameters, is not more than 18%.

10. The magnetic particle according to claim 1, wherein a saturation magnetization of the magnetic particle is in the range of 2 A·m²/kg to 100 A·m²/kg.

11. The magnetic particle according to claim 1, wherein a coercive force of the magnetic particle is in the range of 0.3 kA/m to 15.93 kA/m.

12. The magnetic particle according to claim 1, wherein the substance capable of binding to the target substance is at least one kind of a substance selected from the group consisting of biotin, avidin, streptavidin, neutravidin, protein A and protein G; and/or
the functional group capable of binding to the target substance is at least one kind of a functional group selected from the group consisting of carboxyl group, hydroxyl group, epoxy group, tosyl group, succinimide group, maleimide group, thiol group, thioether group, disulfide group, aldehyde group, azido group, hydrazide group, primary amino group, secondary amino group, tertiary amino group, imide ester group, carbodiimide group, isocyanate group, iodoacetyl group, halogen-substitution of carboxyl group and double bond.

13. A method for producing the magnetic particle according to claim 1, comprising the step of mixing a precursor particle which corresponds to a core particle of the magnetic particle, a monomer and a solvent with each other, and thereby chemically bonding a polymer component derived from the monomer with the precursor particle; and
wherein a polymer shell portion of the magnetic particle, which is made of the chemically-bonded polymer component, is continuously formed on at least part of the surface of the core particle, and thereby roughening the magnetic particle by a surface roughness of the polymer shell portion.

14. The method according to claim 13, wherein an aromatic vinyl monomer is used as the monomer, and thereby forming the polymer shell portion which comprises an aromatic vinyl backbone.

15. A method for producing the magnetic particle according to claim 5, comprising the steps of:
(i) subjecting a precursor particle which corresponds to a core particle of the magnetic particle to a rough-polymer coating treatment, and thereby forming a polymer shell portion on a surface of the precursor particle;
(ii) subjecting the precursor particle from the rough-polymer coating treatment to a hydrophilic-polymer coating treatment, and thereby forming a hydrophilic polymer coat portion on the precursor particle; and
wherein the precursor particle is subjected to a physical dispersion treatment at a point in time between the step (i) and the step (ii).

16. The method according to claim 15, wherein a shear force is applied to the precursor particle in the physical dispersion treatment.

17. The method according to claim 15, wherein a passing of the precursor particle through a slit under pressure is performed in the physical dispersion treatment.

18. The method according to claim 15, wherein, in the step (i), the precursor particle, a monomer and a solvent are mixed with each other, and thereby chemically bonding a polymer component derived from the monomer with the precursor particle; and
wherein the polymer shell portion made of the chemically-bonded polymer component is continuously formed on at least part of the surface of the core particle, and thereby roughening the magnetic particle by a surface roughness of the polymer shell portion.
